(19) United States
(12) Patent Application Publication
(10) Pub. No.: US 2018/0083557 A1
(43) Pub. Date: Mar. 22, 2018

(54) MOTOR DRIVE DEVICE AND MOTOR SYSTEM

(71) Applicant: Renesas Electronics Corporation, Tokyo (JP)

(72) Inventors: Minoru KUROSAWA, Tokyo (JP); Kichiya ITAGAKI, Tokyo (JP); Yusuke YASUMA, Tokyo (JP)

(21) Appl. No.: 15/674,685

(22) Filed: Aug. 11, 2017

(30) Foreign Application Priority Data
Sep. 16, 2016 (JP) 2016-181309

(51) Int. Cl. H02P 6/10; H02P 6/15; G11B 19/20

(52) U.S. Cl. CPC H02P 6/10; G11B 19/2009; H02P 6/157

(57) ABSTRACT

There are provided a motor drive device and a motor system that can reduce the torque ripple of a motor. An SPM drive unit includes a plurality of high side transistors and low side transistors coupled to drive terminals of multiple phases respectively, and applies drive voltages to the drive terminals, using a PWM signal. A back electromotive force voltage phase detection unit detects each of back electromotive force voltage phases of the multiple phases. A drive voltage phase generation unit determines one of drive voltage phases in each of the multiple phases at the time of applying the drive voltages so that each of drive current phases of the multiple phases has a phase variation opposite in direction and equal to each of relative phase variations of the back electromotive force voltage phases of the multiple phases.

### CROSS-REFERENCE TO RELATED APPLICATIONS

The disclosure of Japanese Patent Application No. 2016-181309 filed on Sep. 16, 2016 including the specification, drawings and abstract is incorporated herein by reference in its entirety.

### BACKGROUND

The present invention relates to a motor drive device and a motor system, and more particularly, to a technique for adjusting the drive current phase of a motor.

For example, Japanese Unexamined Patent Publication No. 2010-288396 (Patent Document 1) shows a method for calculating the drive voltage phase of a motor, based on a calculation expression using the angular frequency, drive current value, and characteristic constants (torque constant, impedance value) of the motor. Further, Japanese Unexamined Patent Publication No. 2005-102447 (Patent Document 2) shows a method for controlling the conduction timing of the motor by selecting one of a back electromotive force voltage phase and a drive current phase.

### SUMMARY

There is known a sine wave driving method using three-phase sine waves as a method for driving the motor with high efficiency, low noise, and low vibration. In such a driving method, to drive the motor with high efficiency, a drive current phase is adjusted so that the back electromotive force voltage phase and drive current phase of the motor match with each other. Since the drive current of the motor is generated by applying a drive voltage to the motor, in reality the drive current phase is adjusted by adjusting the drive voltage phase of the motor. It is possible to calculate the optimal drive voltage phase of the motor, for example, based on the calculation expression using the angular frequency, drive current value, and characteristic constants of the motor as shown in Patent Document 1.

For example, on the premise of an ideal motor, with the drive voltage phase of the motor optimized, a motor drive device applies drive voltages having a phase difference of 120 degrees to three phases. However, in an actual motor, there can occur magnetization variation among the phases, due to manufacturing variation, manufacturing limitations, or the like. Due to the occurrence of magnetization variation, the three-phase back electromotive force voltage phase difference varies with respect to 120 degrees, and three-phase back electromotive force voltage amplitudes are not the same and vary from each other. If the motor drive device drives the motor having the magnetization variation by the drive voltages having a phase difference of 120 degrees, a torque ripple occurs. The torque ripple is a factor inhibiting lower noise and lower vibration of the motor.

Embodiments described later have been made in view of the foregoing, and the other problems and novel features will become apparent from the description of this specification and the accompanying drawings.

A motor drive device according to one embodiment has an inverter unit, a back electromotive force voltage phase detection unit, and a drive voltage phase generation unit, and drives a motor of multiple phases provided outside. The inverter unit includes a plurality of high side transistors and low side transistors coupled to drive terminals of the multiple phases respectively, and applies drive voltages to the drive terminals, using a PWM signal. The back electromotive force voltage phase detection unit detects each of back electromotive force voltage phases of the multiple phases. The drive voltage phase generation unit determines a drive voltage phase to each of the multiple phases at the time of applying the drive voltages so that drive current phases of the multiple phases have phase variation opposite in direction and equal in amount to relative phase variation of the back electromotive force voltage phases of the multiple phases.

According to the one embodiment, it is possible to reduce the torque ripple of the motor.

### BRIEF DESCRIPTION OF THE DRAWINGS

FIG. 1 is a functional block diagram showing a schematic configuration example of a motor system according to a first embodiment of the present invention.

FIG. 2 is a functional block diagram showing a configuration example of the main part of a motor drive device according to the first embodiment of the present invention.

FIG. 3 is a waveform diagram showing an example of the back electromotive force voltage, drive current, and torque ripple of a motor in the case where the motor drive device of FIG. 2 drives the motor.

FIG. 4 is a block diagram showing a schematic configuration example of a main part around a drive voltage phase generation unit in the motor drive device of FIG. 2.

FIG. 5 is a waveform diagram showing an example of a detection period of a rotational position detection unit and a phase error detection unit in FIG. 2.

FIG. 6 is a circuit diagram showing a detailed configuration example of a back electromotive force voltage phase detection unit in FIG. 2.

FIG. 7 is a circuit diagram showing a detailed configuration example of a phase error detection unit in FIG. 2.

FIG. 8 is an explanation diagram showing a schematic operation example of the back electromotive force voltage phase detection unit of FIG. 6 and the phase error detection unit of FIG. 7.

FIG. 9 is a circuit diagram showing a detailed configuration example of a drive current phase detection unit in FIG. 2.

FIG. 10 is a waveform diagram showing the operating principle of the drive current phase detection unit of FIG. 9.

FIG. 11 is a diagram showing a detailed configuration example of a phase calculation unit and a phase correction unit in the drive voltage phase generation unit of FIG. 4.

FIG. 12 is a diagram showing a detailed configuration example of an interphase phase variation correction unit in the drive voltage phase generation unit of FIG. 4.

FIG. 13 is a functional block diagram showing a configuration example of the main part of a motor drive device according to a second embodiment of the present invention.

FIG. 14 is a waveform diagram showing an example of the back electromotive force voltage, drive current, and torque ripple of the motor in the case where the motor drive device of FIG. 13 drives the motor.

FIG. 15 is a diagram showing a detailed configuration example of an interphase amplitude variation correction unit in FIG. 13.

FIG. 16 is a waveform diagram for explaining an operation example of the interphase amplitude variation correction unit of FIG. 15.

FIG. 17 is a functional block diagram showing a configuration example of the main part of a motor drive device according to a comparative example of the present invention.

FIG. 18 is a circuit block diagram showing a configuration example of an SPM drive unit in FIG. 17.

FIGS. 19A, 19B, and 19C are explanation diagrams showing the operating principle of a sine wave drive voltage control unit in FIG. 17.

FIG. 20 is an explanation diagram showing the operating principle of the sine wave drive voltage control unit in FIG. 17.

FIG. 21 is a waveform diagram showing an example of the back electromotive force voltage, drive current, and torque ripple of the motor in the case where the motor drive device of FIG. 17 drives the motor.

FIG. 22 is a circuit diagram equivalently showing each phase of the motor.

FIGS. 23A, 23B, and 23C are supplementary drawings of FIG. 21, and are explanation diagrams showing how the drive current phase varies with variation in the back electromotive force voltage phase.

FIG. 24 is a waveform diagram showing an example of the back electromotive force voltage, drive current, and torque ripple of the motor in the case where the motor drive device of FIG. 17 drives the motor.

### DETAILED DESCRIPTION

In the following embodiments, description will be made by dividing an embodiment into a plurality of sections or embodiments when necessary for the sake of convenience; however, except when a specific indication is given, they are not mutually unrelated, but there is a relationship that one section or embodiment is a modification, specification, or supplementary explanation of part or all of another section or embodiment. Further, in the case where the following embodiments deal with a numerical expression (including a number, a numerical value, amount, range) concerning elements, the numerical expression is not limited to the specific number but may be larger or smaller than the specific number except when a specific indication is given or when the expression is apparently limited to the specific number in principle.

Furthermore, in the following embodiments, the components (including element steps) are not always indispensable except when a specific indication is given or when they are apparently considered to be indispensable in principle. Similarly, in the case where the following embodiments deal with the shape, positional relationship, etc., of the components etc., those substantially approximate or similar to them in shape etc. are also included except when a specific indication is given or when they are apparently considered to be excluded in principle. This also applies to numerical values and ranges described above.

Although not restricted, circuit elements configuring each functional block of the embodiments are formed over a semiconductor substrate made of, e.g., monocrystalline silicon, using a known CMOS (Complementary MOS transistor) integrated circuit technology.

Hereinafter, preferred embodiments of the present invention will be described in detail with reference to the accompanying drawings. In all the drawings for illustrating the embodiments, the same components or members are basically denoted by the same reference numerals, and their description will not be repeated.

### First Embodiment

<<Outline of Motor System>>

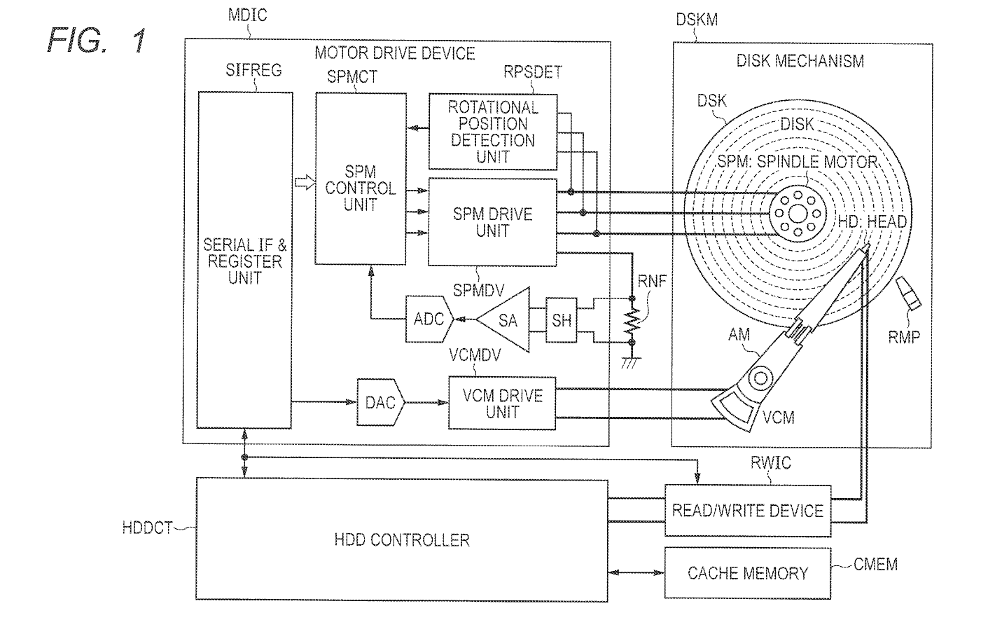

FIG. 1 is a functional block diagram showing a schematic configuration example of a motor system according to the first embodiment of the present invention. FIG. 1 shows a configuration example of a hard disk drive (hereinafter abbreviated as HDD) device as an example of the motor system. The HDD device of FIG. 1 includes an HDD controller HDDCT, a cache memory CMEM, a read/write device RWIC, a motor drive device MDIC, and a disk mechanism DSKM. The HDD controller HDDCT is comprised of, e.g., a system-on-chip (SoC) including a processor or the like. The cache memory CMEM and the read/write device RWIC are comprised of, e.g., different semiconductor chips.

The disk mechanism DSKM includes a disk (hard disk) DSK, a spindle motor (hereinafter abbreviated as motor) SPM, a head HD, an arm mechanism AM, a voice coil motor VCM, and a ramp mechanism RMP. The motor SPM rotationally drives the disk DSK. The voice coil motor VCM controls the position of the head HD in the radial direction of the disk DSK through the arm mechanism AM. The head HD reads/writes data over the disk DSK at a predetermined position determined by the voice coil motor VCM. The ramp mechanism RMP is a retraction place for the head HD when data is not read/written.

The motor drive device MDIC is comprised of, e.g., one semiconductor chip. The motor drive device MDIC includes a digital-analog converter DAC and a VCM drive unit VCMDV to drive the voice coil motor VCM. Further, the motor drive device MDIC includes an SPM control unit SPMCT, a sample hold circuit SH, a sense amplifier circuit SA, an analog-digital converter ADC, an SPM drive unit SPMDV, and a rotational position detection unit RPSDET to drive the motor SPM. Further, the motor drive device MDIC includes a serial IF & register unit SIFREG to set the driving conditions of the motor SPM and the voice coil motor VCM.

The read/write device RWIC drives the head HD to cause the head HD to read/write data. The HDD controller HDDCT controls the whole HDD device. For example, the HDD controller HDDCT communicates with the serial IF & register unit SIFREG of the motor drive device MDIC, and thereby indicates the driving conditions of the motor SPM and the voice coil motor VCM and the like to the motor drive device MDIC. Further, for example, the HDD controller HDDCT instructs the read/write device RWIC to read/write data. At this time, write data to be indicated to the read/write device RWIC and data read from the head HD through the read/write device RWIC are stored in the cache memory CMEM.

Next, the overall operation of the HDD device will be briefly described. First, when the motor drive device MDIC receives a start command of the motor SPM from the HDD controller HDDCT, the motor drive device MDIC drives the motor SPM through the SPM drive unit SPMDV, using a PWM (Pulse Width Modulation) signal generated by the SPM control unit SPMCT. A current detecting resistance RNF detects the drive current of the motor SPM.

The drive current of the motor SPM is converted into a digital value by the sample hold circuit SH, the sense amplifier circuit SA, and the analog-digital converter ADC. Based on an error between the detection value (digital value) of the drive current and a current instruction value as the target value of the drive current, the SPM control unit SPMCT generates a PWM signal for reducing the error. The current instruction value is indicated, for example, by the HDD controller HDDCT.

The rotational position detection unit RPSDET detects, for example, the back electromotive force voltage (referred to as BEMF in this specification) of the motor SPM, and thereby detects the rotational position of the motor SPM. The SPM control unit SPMCT outputs the PWM signal for bringing the drive current of the motor SPM close to the current instruction value to the SPM drive unit SPMDV, at an appropriate timing according to the rotational position of the motor SPM, and thereby controls the motor SPM (i.e., the disk DSK) to rated rotation. After the motor SPM reaches a rated rotation state, the VCM drive unit VCMDV moves the head HD onto the disk DSK, and the head HD reads/writes data over the disk DSK.

Such a motor system is required to enhance efficiency and reduce noise and vibration. Particularly, in the HDD device, it is important to reduce vibration from the viewpoint of the improvement of recording density, the improvement of positioning accuracy by servo writing, and the like. Accordingly, it is useful to use the motor drive device according to the first embodiment described later.

<<Schematic Configuration and Schematic Operation of Motor Drive Device (Comparative Example)>>

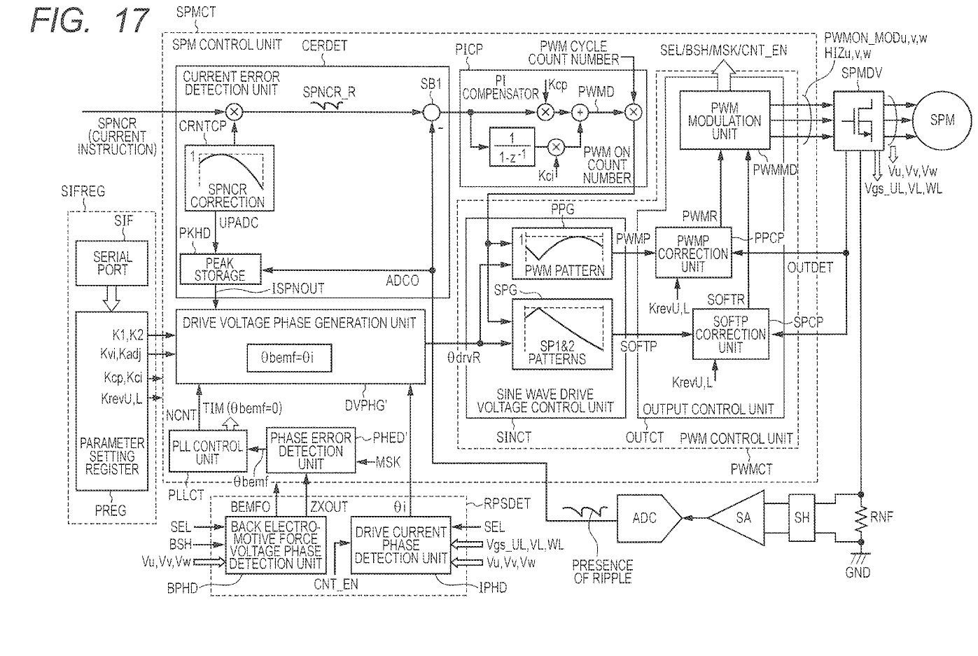

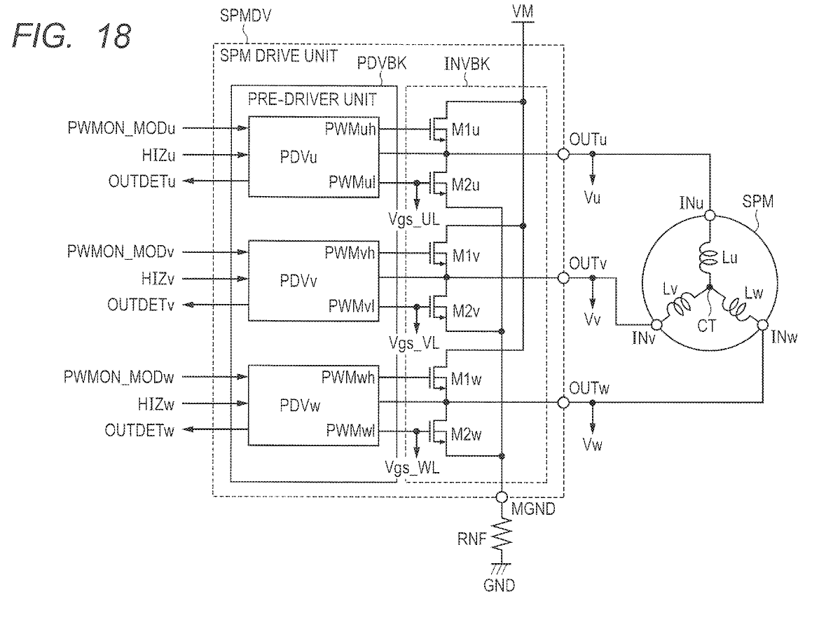

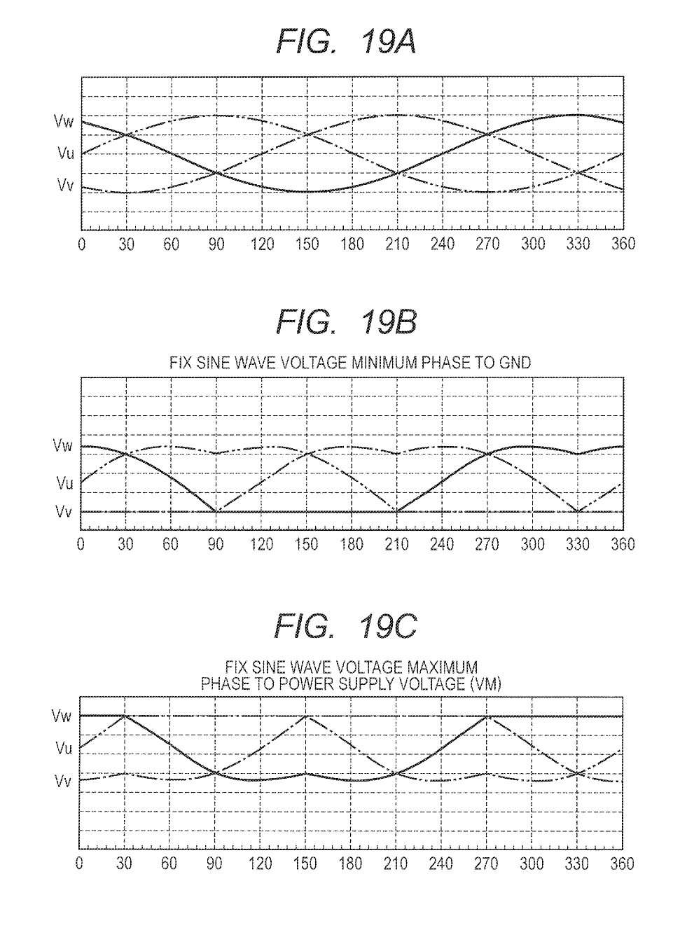

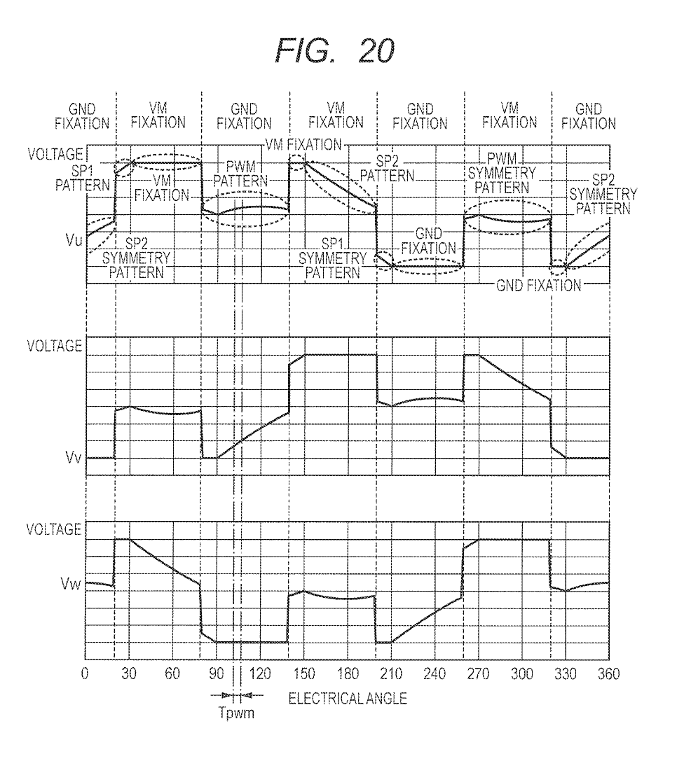

First, a motor drive device according to a comparative example will be described before describing the motor drive device according to the first embodiment. FIG. 17 is a functional block diagram showing a configuration example of the main part of the motor drive device according to the comparative example of the present invention. FIG. 18 is a circuit block diagram showing a configuration example of the SPM drive unit in FIG. 17. FIGS. 19A, 19B, 19C, and 20 are explanation diagrams showing the operating principle of a sine wave drive voltage control unit in FIG. 17.

FIG. 17 shows the SPM control unit SPMCT, the SPM drive unit SPMDV, the rotational position detection unit RPSDET, the serial IF & register unit SIFREG, the sample hold circuit SH, the sense amplifier circuit SA, and the analog-digital converter ADC, extracted from the motor drive device MDIC of FIG. 1. Further, the current detecting resistance RNF and the motor SPM in the disk mechanism DSKM are also shown, which are provided outside the motor drive device MDIC.

As described above, the current detecting resistance RNF detects and converts the drive current of the motor SPM into a voltage, and the sample hold circuit SH sequentially holds the detection voltage at a predetermined timing. More specifically, the sample hold circuit SH performs sampling at the timing of detecting a drive current to each of three phases (u phase, v phase, w phase) of the motor SPM, and thereby holds the detection voltage proportional to the drive current of each phase. The sense amplifier circuit SA amplifies the held detection voltage, and the analog-digital converter ADC converts the amplified voltage into a digital value.

The rotational position detection unit RPSDET has a back electromotive force voltage phase detection unit BPHD and a drive current phase detection unit IPHD. The back electromotive force voltage phase detection unit BPHD detects each of the back electromotive force voltage phases (referred to as BEMF phases in this specification) of the three phases of the motor SPM. In this example, the back electromotive force voltage phase detection unit BPHD selects a phase in which the BEMF phase is detected, in accordance with a phase selection signal SEL, and outputs a zero-cross detection signal ZXOUT at the time of detecting the voltage zero-cross point of the BEMF of the selected phase. The drive current phase detection unit IPHD detects a drive current phase of at least one of the three phases of the motor SPM in accordance with the phase selection signal SEL. Further, the drive current phase detection unit IPHD determines a reference current phase θi based on the detected drive current phase. More specifically, the drive current phase detection unit IPHD determines, for example, the average or representative phase of the three-phase drive current phases as the reference current phase θi.

The SPM control unit SPMCT includes a phase error detection unit PHED′, a PLL control unit PLLCT, a drive voltage phase generation unit DVPHG′, a current error detection unit CERDET, a PI compensator PICP, and a PWM control unit PWMCT. The phase error detection unit PHED′ determines a reference voltage phase θbemf based on the three-phase BEMF phases (output timings of the zero-cross detection signal ZXOUT in this example) detected by the back electromotive force voltage phase detection unit BPHD. More specifically, the phase error detection unit PHED′ determines, for example, the average or representative phase of the three-phase BEMF phases as the reference voltage phase θbemf.

The PLL (Phase Locked Loop) control unit PLLCT generates a conduction timing signal TIM which periodically transitions in synchronization with the BEMF. More specifically, the PLL control unit PLLCT controls the phase of the conduction timing signal TIM by a PLL so that the phase difference between the phase of the conduction timing signal TIM and the reference voltage phase θbemf converges to zero. The conduction of the motor SPM is controlled based on the conduction timing signal TIM. Further, the PLL control unit PLLCT generates a rotation cycle count value NCNT. The rotation cycle count value NCNT is a value obtained by converting a time proportional to one cycle of the BEMF (i.e., the rotation cycle of the motor SPM) into the count value of a reference clock of digital control, and is a value inversely proportional to the angular frequency (ω) of the motor SPM.

The current error detection unit CERDET detects an error between a current instruction value SPNCR and a digital value (i.e., the detection value of the drive current of each phase) outputted from the analog-digital converter ADC, using a subtractor SB1. The current instruction value SPNCR is indicated, for example, by the HDD controller HDDCT of FIG. 1, as described above. The HDD controller HDDCT receives, for example, the information of the angular frequency of the motor SPM obtained from the rotation cycle count value NCNT or the like, and generates the current instruction value SPNCR for setting the angular frequency to a target angular frequency by a predetermined calculation.

The PI compensator PICP performs proportional integration (PI) control, with the error value detected by the current error detection unit CERDET as an input, and thereby calculates a PWM duty value PWMD reflecting the current error. Then, the PI compensator PICP multiplies the PWM duty value PWMD by a predetermined PWM cycle count number, and thereby calculates a PWM on count number. The PWM cycle count number is a number obtained by converting the time of one cycle of the PWM signal into the count value of the reference clock of digital control, and the PWM on count number is a number obtained by converting an ON period in one cycle of the PWM signal into the count value.

The PWM control unit PWMCT includes a sine wave drive voltage control unit SINCT and an output control unit OUTCT. Roughly, the PWM control unit PWMCT receives the conduction timing signal TIM synchronized with the BEMF from the PLL control unit PLLCT, and generates PWM signals PWMON_MODu, PWMON_MODv, PWMON_MODw for controlling three-phase drive voltages (Vu, Vv, Vw) applied to the motor SPM to a sine wave shape.

The sine wave drive voltage control unit SINCT receives the PWM on count number from the PI compensator PICP, and generates a duty instruction value, for each PWM cycle, which is necessary to apply three-phase sine wave voltages to the motor SPM. The duty instruction value represents the ratio of the ON period in the PWM cycle. More specifically, the sine wave drive voltage control unit SINCT includes a PWM pattern generation unit PPG for generating a duty instruction value PWMP for a PWM pattern and a soft pattern generation unit SPG for generating a duty instruction value SOFTP for a soft pattern (SP1, SP2).

The PWM pattern generation unit PPG and the soft pattern generation unit SPG generate duty instruction values based on a principle shown in FIGS. 19A, 19B, 19C, and 20. First, FIG. 19A shows the ideal three-phase drive voltages Vu, Vv, Vw applied to the motor SPM in the case of applying a so-called sine wave driving method (i.e., a method for controlling the drive current of the motor SPM to the sine wave shape) as the driving method of the motor SPM. The drive voltages Vu, Vv, Vw are sine wave voltages having a phase difference of 120 degrees with respect to each other.

FIG. 19B shows the voltage waveform of each phase in the case of fixing the voltage of a voltage minimum phase among the three-phase drive voltages Vu, Vv, Vw shown in FIG. 19A to a ground power supply voltage GND (referred to as GND fixation in this specification). For example, in FIG. 19A, the u phase is the voltage minimum phase in a period between 210 and 330 electrical degrees, so that FIG. 19B shows the relative voltage waveforms of the v and w phases in the case of applying the GND fixation to the u-phase drive voltage Vu during the period. In the same way as in FIG. 19B, FIG. 19C shows the voltage waveform of each phase in the case of fixing the voltage of a voltage maximum phase among the three-phase drive voltages Vu, Vv, Vw shown in FIG. 19A to a power supply voltage VM (referred to as VM fixation in this specification).

By alternately switching between the GND fixation of FIG. 19B and the VM fixation of FIG. 19C every 60 electrical degrees, voltage waveforms as shown in FIG. 20 are obtained. As shown in FIG. 20, the drive voltage Vu of the u phase (as well as the v phase and the w phase) for sine wave drive can be created by appropriately combining the SP1 pattern, the PWM pattern, the SP2 pattern, symmetry patterns of these patterns, the VM fixation, and the GND fixation.

More specifically, a period between 0 and 360 electrical degrees shown in FIG. 20 corresponds to, for example, a period of about 100 PWM cycles Tpwm. In the PWM cycle Tpwm shown in FIG. 20, in a state where the GND fixation is applied to the w phase, the PWM pattern is applied to the u phase, and the SP2 symmetry pattern is applied to the v phase. In the same way, in each PWM cycle, the GND fixation or the VM fixation is applied to one of the three phases, the PWM pattern or the PWM symmetry pattern is applied to another phase, and the SP1 pattern, the SP2 pattern, or a symmetry pattern of any of these patterns is applied to the other phase.

Based on this principle, for example, the PWM pattern generation unit PPG stores the duty instruction value, for each PWM cycle, to achieve the voltage change of the PWM pattern shown in FIG. 20, in a table or the like, and generates the duty instruction value PWMP based on the table. The duty instruction value PWMP is represented, for example, by the count value on the basis of the reference clock of digital control.

The table stores, for example, a normalized duty instruction value (e.g., count value). The PWM pattern generation unit PPG assigns to the normalized duty instruction value a weight on the basis of the PWM on count number from the PI compensator PICP, and generates the duty instruction value PWMP. As a result, the PWM pattern generation unit PPG can generate the duty instruction value PWMP, for performing sine-wave drive of the motor SPM, reflecting the current error. Similarly, the soft pattern generation unit SPG also can generate the duty instruction value SOFTP, for performing sine-wave drive of the motor SPM, reflecting the current error.

The output control unit OUTCT includes a PWMP correction unit PPCP, a SOFTP correction unit SPCP, and a PWM modulation unit PWMMD. The PWMP correction unit PPCP detects a duty error that occurs between the input and output of the SPM drive unit SPMDV, and adds a correction value for canceling the error to the duty instruction value PWMP, and thereby generates a corrected duty instruction value PWMR. More specifically, the PWMP correction unit PPCP detects an actual duty from an output detection signal OUTDET from the SPM drive unit SPMDV, and determines the correction value based on the difference between the duty and the duty instruction value PWMP.

Further, if the duty instruction value PWMP is larger than a duty determined by a PWM correction parameter KrevU,L, the PWMP correction unit PPCP determines the correction value based on a predetermined calculation expression. That is, in the case where the duty instruction value PWMP is large, due to insufficient on/off of a transistor, there might be required a different correction value from a value in the case where the duty instruction value PWMP is small. The PWMP correction unit PPCP determines the correction value based on the calculation expression. In the same way as in the PWMP correction unit PPCP, the SOFTP correction unit SPCP adds a predetermined correction value to the duty instruction value SOFTP, and thereby generates a corrected duty instruction value SOFTR.

Thus, by correcting the duty error that occurs between the input and output of the SPM drive unit SPMDV, it is possible to reduce distortion in the sine wave voltage (sine wave current generated as a result thereof) applied to the motor SPM. By reducing the distortion, it is possible to reduce the noise and vibration of the motor.

The PWM modulation unit PWMMD controls actual conduction to the motor, based on the conduction timing signal TIM from the PLL control unit PLLCT. More specifically, the PWM modulation unit PWMMD switches between the GND fixation and the VM fixation every 60 degrees, as shown in FIG. 20. In accordance with the switching, the PWM modulation unit PWMMD generates the PWM signals PWMON_MODu, PWMON_MODv, PWMON_MODw for the u phase, the v phase, and the w phase respectively, based on the corrected duty instruction values PWMR, SOFTR.

More specifically, the PWM modulation unit PWMMD fixes one of the three-phase PWM signals to the ON period or the OFF period (i.e., the VM fixation or the GND fixation), based on the driving method of FIG. 20. The PWM modulation unit PWMMD determines the ON period of the PWM signal of another phase by one of the corrected duty instruction values PWMR, SOFTR, and determines the ON period of the PWM signal of the other phase by the other of the corrected duty instruction values PWMR, SOFTR. In reality, the symmetry patterns of the PWM pattern and the soft patterns are also necessary, as shown in FIG. 20. The PWM modulation unit PWMMD also generates PWM signals corresponding to these symmetry patterns by digital calculation.

Further, in order that the back electromotive force voltage phase detection unit BPHD detects the BEMF phases and the phase error detection unit PHED determines the reference voltage phase θbemf, it is necessary to control the u phase, the v phase, and the w phase of the motor SPM to high impedance temporarily at around the voltage zero-cross point. The PWM modulation unit PWMMD generates high impedance control signals HIZu, HIZv, HIZw to control the u phase, the v phase, and the w phase to high impedance temporarily, respectively. At this time, the PWM modulation unit PWMMD generates a mask signal MSK indicating a period (in other words, the detection period of the BEMF phase) during which one of the phases is controlled to high impedance, and outputs it to the phase error detection unit PHED′.

Thus, by using the driving method of FIG. 20, the number of actual circuits, in the PWM modulation unit PWMMD, for generating the PWM signal based on the corrected duty instruction value (count value) can be two instead of three, which can reduce a circuit area. Further, by using the driving method of FIG. 20, it is possible to perform control by an amplitude from the VM fixation or the GND fixation, which is advantageous for a power supply voltage margin, and can increase the torque constant of the motor SPM and reduce power consumption.

The SPM drive unit SPMDV includes a pre-driver unit PDVBK and an inverter unit INVBK, as shown in FIG. 18. The inverter unit INVBK includes a high side transistor M1u and a low side transistor M2u for the u phase, a high side transistor M1v and a low side transistor M2v for the v phase, and a high side transistor M1w and a low side transistor M2w for the w phase. Although not restricted, the high side transistors M1u, M1v, M1w and the low side transistors M2u, M2v, M2w are N-channel MOS transistors in this specification.

The drains of the high side transistors M1u, M1v, M1w are coupled in common to the power supply voltage VM, and the sources of the low side transistors M2u, M2v, M2w are coupled in common to a motor ground terminal MGND. The source of the high side transistor M1u and the drain of the low side transistor M2u are coupled to a drive output terminal OUTu for the u phase. Similarly, the high side transistor M1v and the low side transistor M2v are coupled to a drive output terminal OUTv for the v phase, and the high side transistor M1w and the low side transistor M2w are coupled to a drive output terminal OUTw for the w phase. The motor ground terminal MGND is coupled to the ground power supply voltage GND through the current detecting resistance RNF.

The drive output terminals OUTu, OUTv, OUTw for the u phase, the v phase, and the w phase are coupled to drive input terminals INu, INv, INw for the u phase, the v phase, and the w phase of the motor SPM, respectively. Further, the drive voltages Vu, Vv, Vw for the u phase, the v phase, and the w phase are outputted from the drive output terminals OUTu, OUTv, OUTw for the u phase, the v phase, and the w phase, respectively. The drive voltages Vu, Vv, Vw have voltage waveforms as shown in FIG. 20 from the viewpoint of time average, and are PWM signals from the viewpoint of each time point. The motor SPM includes coils Lu, Lv, Lw for the u phase, the v phase, and the w phase which are equivalently star-connected between a neutral point CT and the drive input terminals INu, INv, INw, respectively.

The pre-driver unit PDVBK includes pre-drivers PDVu, PDVv, PDVw for the u phase, the v phase, and the w phase. Based on the PWM signal PWMON_MODu for the u phase from the PWM modulation unit PWMMD, the pre-driver PDVu for the u phase drives the high side transistor M1u for the u phase by a PWM signal PWMuh, and drives the low side transistor M2u by a PWM signal PWMul which is the complementary signal of the PWM signal PWMuh.

Further, if the high impedance control signal HIZu is at a high level, the pre-driver PDVu drives both the high side transistor M1u and the low side transistor M2u to OFF. Thereby, the drive output terminal OUTu becomes high impedance, which makes it possible to observe the u-phase BEMF at the drive output terminal OUTu. Further, the pre-driver PDVu converts the PWM signal outputted from the drive output terminal OUTu into a pulse signal of a predetermined voltage level, and outputs the pulse signal as the output detection signal OUTDETu. Although detailed description is omitted, the same applies to the pre-driver PDVv for the v phase and the pre-driver PDVw for the w phase.

Referring back to FIG. 17, the PWM modulation unit PWMMD outputs the PWM signal to the SPM drive unit SPMDV while performing switching every 60 electrical degrees as described above. Since the drive current of the motor SPM is shaped like a sine wave, the current detected by the current detecting resistance RNF is a current obtained by repeating a cycle of 60 degrees including the peak of the sine wave. Accordingly, the current error detection unit CERDET includes an instruction current correction unit CRNTCP for generating a digital pattern obtained by copying the sine waveform. The current error detection unit CERDET multiplies the current instruction value SPNCR by the digital pattern from the instruction current correction unit CRNTCP, and outputs to the subtractor SB1 a current instruction value SPNCR_R as a multiplication result, in place of the current instruction value SPNCR.

Further, the current error detection unit CERDET includes a peak storage unit PKHD. The peak storage unit PKHD stores a digital value ADCO from the analog-digital converter ADC by receiving a trigger signal UPADC from the instruction current correction unit CRNTCP, and thereby outputs a drive current amplitude ISPNOUT of each phase. The instruction current correction unit CRNTCP outputs the trigger signal UPADC, for example, at the position of the maximum amplitude of the generated digital pattern.

The drive voltage phase generation unit DVPHG′ determines a reference drive voltage phase θdrvR at the time of applying the drive voltages to the drive terminals (OUTu,v,w and INu,v,w) so that the phase difference between the reference voltage phase θbemf and the reference current phase θi is set to zero. More specifically, in order that the BEMF phase (in other words, the reference voltage phase θbemf) and the drive current phase (in other words, the reference current phase θi) of the motor SPM match with each other, it is necessary to apply to the motor SPM the drive voltage whose phase is advanced by the drive voltage phase θdrvR from the reference voltage phase θbemf. The drive voltage phase generation unit DVPHG′ determines the drive voltage phase θdrvR, and indicates it to the PWM control unit PWMCT. At this time, the drive voltage phase generation unit DVPHG′ indicates the drive voltage phase θdrvR as an advanced angle phase applicable in common to the three phases, on the premise of an ideal motor SPM.

The PWM control unit PWMCT receives the drive voltage phase θdrvR, shifts the conduction timing signal TIM based on the drive voltage phase θdrvR, and generates the PWM signals PWMON_MODu,v,w for controlling the three-phase drive voltages to the sine wave shape, based on the shifted conduction timing signal. In this example, the sine wave drive voltage control unit SINCT shifts the PWM pattern and the soft pattern shown in FIG. 20 by an electrical angle on the basis of the drive voltage phase θdrvR, and generates the duty instruction values PWMP, SOFTP, using the shifted patterns. As a result, the phases of the drive voltages Vu, Vv, Vw are controlled based on the drive voltage phase θdrvR, and the drive current phase of each phase of the motor SPM is also controlled based on the drive voltage phase θdrvR accordingly.

The serial IF & register unit SIFREG includes a serial port SIF and a parameter setting resister unit PREG accessed through the serial port. The parameter setting resister unit PREG stores, for example, various parameters set by the HDD controller HDDCT of FIG. 1. The various parameters include characteristic constants K1, K2 of the motor SPM, gain adjustment parameters Kvi, Kadj, current control parameters Kcp, Kci, and the PWM correction parameter KrevU,L.

The characteristic constants K1, K2 and the gain adjustment parameters Kvi, Kadj are used by the drive voltage phase generation unit DVPHG′. The current control parameters Kcp, Kci are used as the proportional gain and integration gain of PI control in the PI compensator PICP. The PWM correction parameter KrevU,L is used by the PWMP correction unit PPCP and the SOFTP correction unit SPCP, as described above.

<<Problem of Motor Drive Device (Comparative Example)>>

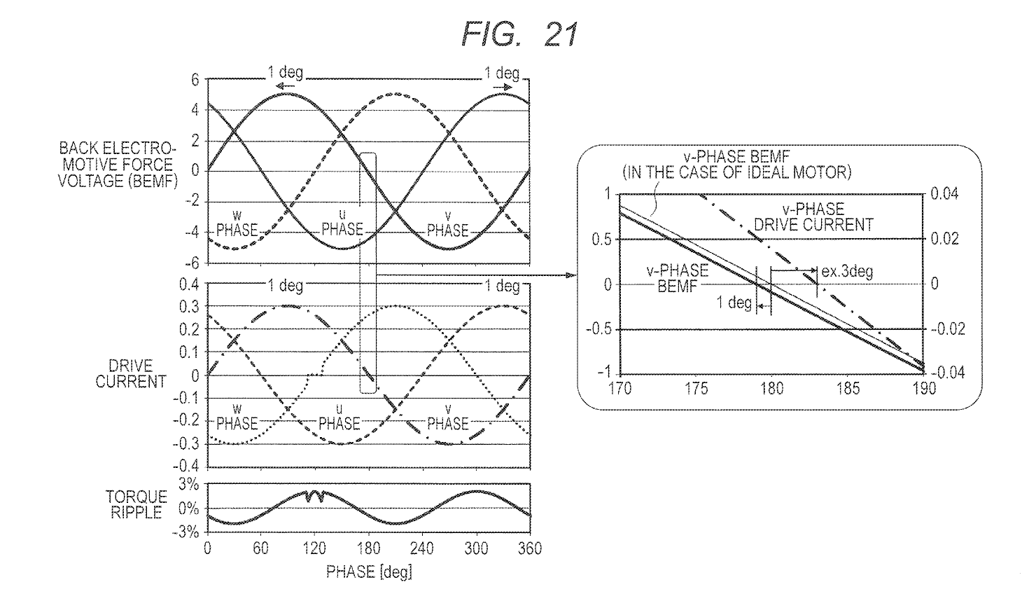

FIG. 21 is a waveform diagram showing an example of the back electromotive force voltage, drive current, and torque ripple of the motor in the case where the motor drive device of FIG. 17 drives the motor. BEMFs in the case of using the ideal motor SPM are sine wave voltages that are 120 degrees out of phase with each other in the u phase, the v phase, and the w phase. However, the BEMF phase in the case of using an actual motor SPM might vary with respect to the BEMF phase in the case of using the ideal motor SPM, as shown in FIG. 21.

In the example of FIG. 21, the BEMF phases of the u phase, the v phase, and the w phase are delayed by 1 degree, advanced by 1 degree, and not varied, with respect to the BEMF phase of the ideal motor SPM, respectively. Such interphase variation of the BEMF phase is referred to as magnetization variation, and is mainly caused by the structure of the motor SPM. Variation factors include, for example, a physical placement error (displacement in the rotational direction) among the u phase, the v phase, and the w phase of a stator in a brushless DC motor.

The motor drive device shown in FIG. 17 determines the drive voltage phase θdrvR common to each phase, on the premise of the ideal motor as described above. In the example of FIG. 21, the motor drive device detects the w-phase BEMF phase by asserting the high impedance control signal HIZw at around the voltage zero-cross point of the rise of the w phase, determines the drive voltage phase θdrvR so that the w-phase drive current phase matches the detected BEMF phase, and applies it to the u phase and the v phase. During this high impedance period, the w-phase drive current is zero as shown in FIG. 21.

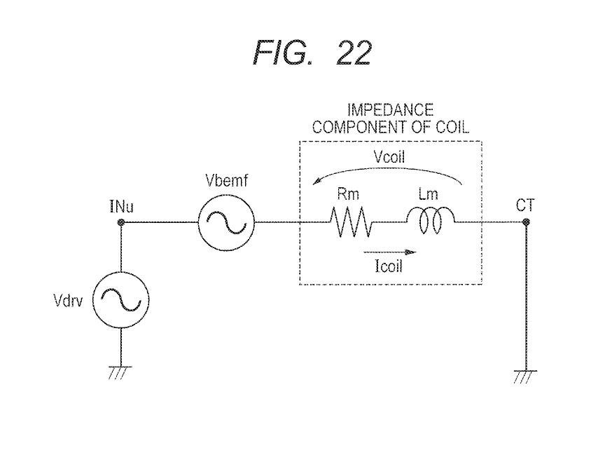

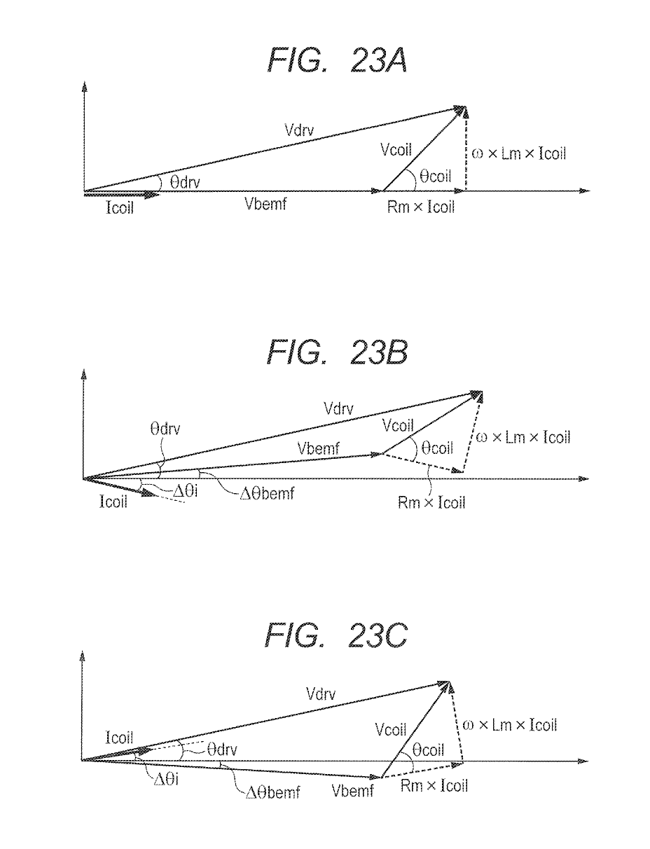

Thus, magnetization variation in the BEMF phase might cause variation in the drive current phase. Although details will be described in FIGS. 22 and 23A to 23C; if the BEMF phase varies in the advancing direction, the drive current phase varies in the delaying direction, whereas if the BEMF phase varies in the delaying direction, the drive current phase varies in the advancing direction. More specifically, there is a case where if the v-phase BEMF phase is advanced by 1 degree, the v-phase drive current phase is delayed by about 3 degrees, as shown in FIG. 21. Thus, inappropriate variation in the BEMF phase and the drive current phase increases the torque ripple, which might increase noise and vibration in motor drive.

FIG. 22 is a circuit diagram equivalently showing each phase of the motor. FIGS. 23A, 23B, and 23C are supplementary drawings of FIG. 21, and are explanation diagrams showing how the drive current phase varies with variation in the back electromotive force voltage phase. In FIG. 22, each phase (the u phase as an example) of the motor SPM is represented by a back electromotive force voltage Vbemf, a motor resistance Rm, and a motor inductance Lm which are coupled in series between the drive input terminal INu and the neutral point CT. The motor resistance Rm and the motor inductance Lm represent the actual impedance component of the coil Lu of FIG. 18. The motor drive device applies a drive voltage Vdrv (e.g., the u-phase drive voltage Vu) to this series circuit to feed a drive current Icoil (e.g., a u-phase drive current Iu) through the coil (Rm and Lm).

FIG. 23A is a vector diagram in the case where the BEMF phase is not relatively shifted (in the case of the ideal motor), and corresponds to e.g. the w phase in FIG. 21. In the case of no phase shift, the phase of the drive current Icoil (drive current phase) matches the phase of the back electromotive force voltage Vbemf (BEMF phase). The amplitude and drive voltage phase θdrv of the drive voltage Vdrv are determined by the vector addition of the back electromotive force voltage Vbemf and a coil voltage Vcoil. The amplitude and phase θcoil of the coil voltage Vcoil are determined by the vector addition of “Rm×Icoil” and “ω×Lm×Icoil” (ω denotes the rotation number (angular frequency) of the motor).

FIG. 23B is a vector diagram in the case where the BEMF phase is relatively advanced, and corresponds to e.g. the v phase in FIG. 21. With respect to FIG. 23A, if the phase of the back electromotive force voltage Vbemf (BEMF phase) is advanced by Δθbemf, first the amplitude of the coil voltage Vcoil is decreased, and the drive current Icoil is also decreased. Then, by the current control described with FIG. 17, the amplitudes of the drive current Icoil and the coil voltage Vcoil are returned to the same amplitudes as in FIG. 23A. As a result, as shown in FIG. 23B, the amplitude of the drive voltage Vdrv is increased, and the drive current phase is delayed by Δθi.

FIG. 23C is a vector diagram in the case where the BEMF phase is relatively delayed, and corresponds to e.g. the u phase in FIG. 21. If the BEMF phase is delayed by Δθbemf, first the amplitude of the coil voltage Vcoil is increased, and the drive current Icoil is also increased. Then, by the current control described with FIG. 17, the amplitudes of the drive current Icoil and the coil voltage Vcoil are returned to the same amplitudes as in FIG. 23A. As a result, as shown in FIG. 23C, the amplitude of the drive voltage Vdrv is decreased, and the drive current phase is advanced by Δθi.

### Schematic Configuration and Schematic Operation of Motor Drive Device (First Embodiment)

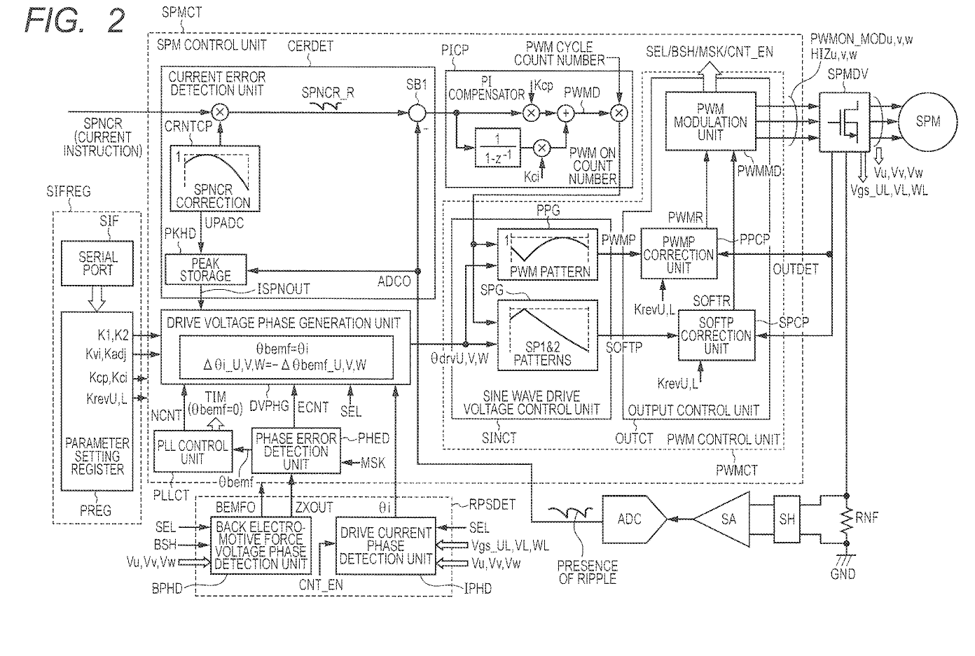

FIG. 2 is a functional block diagram showing a configuration example of the main part of the motor drive device according to the first embodiment of the present invention. In the motor drive device MDIC shown in FIG. 2, the configurations and operations of a drive voltage phase generation unit DVPHG and a phase error detection unit PHED are different in comparison with the configuration example of FIG. 17.

The phase error detection unit PHED determines the reference voltage phase θbemf based on three-phase back electromotive force voltage phases detected by the back electromotive force voltage phase detection unit BPHD, as in FIG. 17. More specifically, the phase error detection unit PHED determines, for example, the average or representative phase of the three-phase BEMF phases as the reference voltage phase θbemf. In addition, the phase error detection unit PHED detects voltage phase errors (Δθbemf_U,V,W) between the three-phase back electromotive force voltage phases and the reference voltage phase θbemf, in each of the three phases, and outputs one of the voltage phase errors in each of the three phases as a phase error signal ECNT to the drive voltage phase generation unit DVPHG.

The drive voltage phase generation unit DVPHG sets the phase difference between the reference voltage phase θbemf and the reference current phase θi to zero, and determines drive voltage phases θdrvU, θdrvV, θdrvW to each of the three phases so that the three-phase drive current phases have phase variation opposite in direction and equal in amount to relative phase variation of the three-phase back electromotive force voltage phases, based on the phase error signal ECNT. For example, in the case of the u phase, the relative phase variation of the u-phase BEMF phase is obtained as the voltage phase error Δθbemf_U. Based thereon, the drive voltage phase generation unit DVPHG determines the u-phase drive voltage phase θdrvU so that the relative phase variation ‘θi_U’ of the u-phase drive current phase becomes opposite in direction and equal in amount to the voltage phase error Δθbemf_U.

The PWM control unit PWMCT receives the drive voltage phases θdrvU, θdrvV, θdrvW, shifts the conduction timing signal TIM whose phase difference from the reference voltage phase θbemf becomes zero, based on the drive voltage phases θdrvU, θdrvV, θdrvW, and generates the PWM signals PWMON_MODu,v,w, based on the shifted conduction timing signal. For example, in the case of the u phase, the PWM control unit PWMCT shifts the conduction timing signal TIM based on the drive voltage phase θdrvU, and generates the PWM signal PWMON_MODu based on the shifted conduction timing signal.

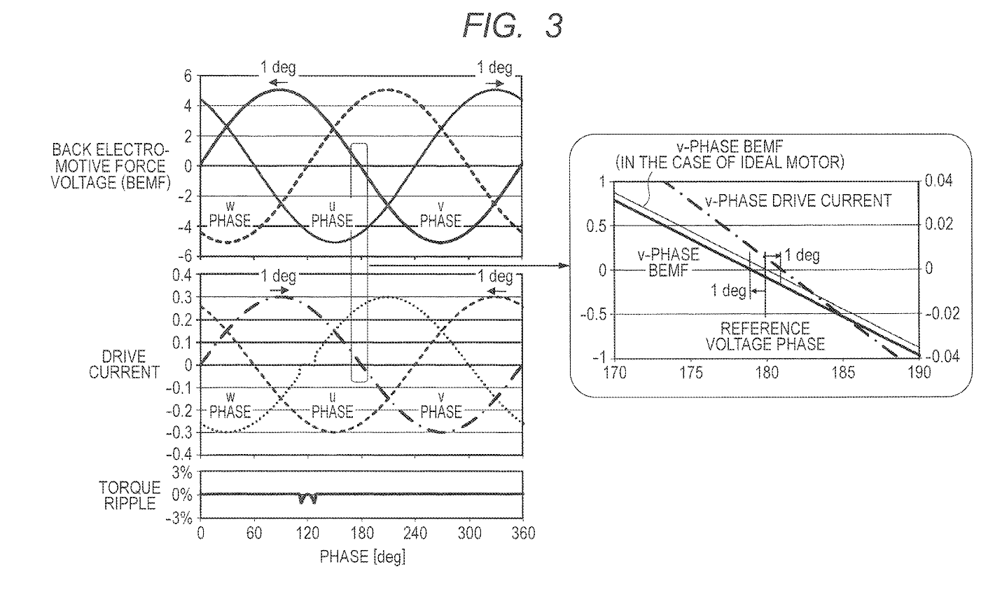

FIG. 3 is a waveform diagram showing an example of the back electromotive force voltage, drive current, and torque ripple of the motor in the case where the motor drive device of FIG. 2 drives the motor. In FIG. 3, in the three-phase back electromotive force voltage phases (BEMF phases), the u phase is relatively delayed by 1 degree, and the v phase is relatively advanced by 1 degree, as in FIG. 21. With the configuration example of FIG. 2, if the BEMF phase is shifted by Δθbemf with respect to the reference voltage phase θbemf, the drive current phase is controlled so as to be shifted by the same amount (i.e., −Δθbemf) as and in the opposite direction of the BEMF phase shift with respect to the reference current phase θi (=reference voltage phase θbemf).

For example, as shown in FIG. 3, if the v-phase BEMF phase is advanced by 1 degree, the v-phase drive current phase is controlled through the drive voltage phase θdrvV so as to be delayed by 1 degree from by about 3 degrees in FIG. 21. In the same way, if the u-phase BEMF phase is delayed by 1 degree, the u-phase drive current phase is controlled through the drive voltage phase θdrvU so as to be advanced by 1 degree. Thereby, it is possible to reduce the torque ripple and suppress noise and vibration in motor drive even in the presence of magnetization variation of the motor.

Qualitatively, the torque of each phase is determined by “torque constant×drive current”. Since the torque constant is “BEMF/ω” (ω is a motor rotation number), the torque of each phase is a function of “BEMF×drive current”. Assuming that the BEMF waveform of a phase in which the BEMF phase is shifted by Δθbemf with respect to the reference voltage phase θbemf is expressed by “sin (ω·t+Δθbemf)”, the drive current waveform of the phase in the case of using the method of the first embodiment is expressed by “sin(ω·t−Δθbemf)”. By multiplying these two sine waves together, the phase shift ‘Δθbemf’ is canceled; therefore, the phase of the torque obtained by the multiplication result is equal to the phase of torque obtained in the state of no magnetization variation. As a result, it is possible to reduce the torque ripple.

<<Outline of Drive Voltage Phase Generation Unit>>

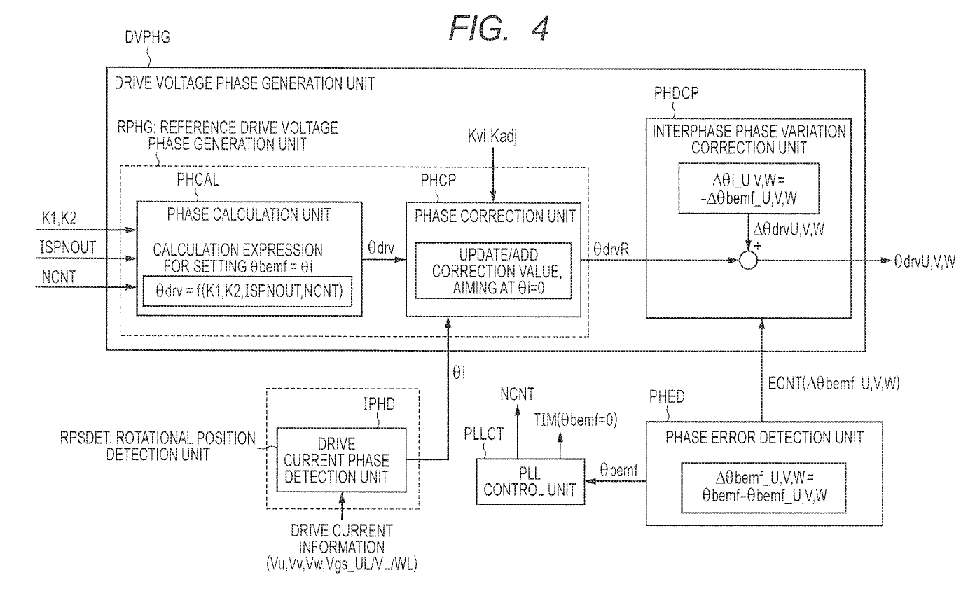

FIG. 4 is a block diagram showing a schematic configuration example of a main part around the drive voltage phase generation unit in the motor drive device of FIG. 2. FIG. 4 shows the drive voltage phase generation unit DVPHG, the phase error detection unit PHED, the drive current phase detection unit IPHD, and the PLL control unit PLLCT in FIG. 2. The drive voltage phase generation unit DVPHG includes a reference drive voltage phase generation unit RPHG and an interphase phase variation correction unit PHDCP.

The reference drive voltage phase generation unit RPHG includes a phase calculation unit PHCAL and a phase correction unit PHCP, and determines the reference drive voltage phase θdrvR at the time of applying the drive voltage so that the phase difference between the reference voltage phase θbemf and the reference current phase θi is set to zero. The phase calculation unit PHCAL calculates the drive voltage phase θdrv for setting the phase difference between the reference voltage phase θbemf and the reference current phase θi to zero, based on a calculation expression using the current value of the drive current of each phase of the motor SPM, the angular frequency ω of the motor SPM, and the characteristic constants K1, K2 of the motor SPM determined by the parameter setting resister unit PREG of FIG. 2. The current value of the drive current is obtained by the drive current amplitude ISPNOUT from the peak storage unit PKHD of FIG. 2, and the angular frequency ω of the motor SPM is obtained by the rotation cycle count value NCNT from the PLL control unit PLLCT.

The drive voltage phase θdrv calculated by the phase calculation unit PHCAL changes according to the characteristic constants K1, K2 of the motor SPM. The characteristic constants K1, K2 are determined, for example, for each type of the motor. However, for example, even in the case of motors SPM of the same type, there might occur variation in the characteristic constants K1, K2 among the motors due to manufacturing variation or the like. Further, even in the case of one motor SPM, due to deterioration with time, there might occur variation in the characteristic constants K1, K2 in a time series manner. This causes an error from zero in the phase difference between the reference voltage phase θbemf and the reference current phase θi, which might reduce the efficiency of the motor and increase power consumption.

For this reason, the phase correction unit PHCP adds a correction value to the drive voltage phase θdrv from the phase calculation unit PHCAL, and thereby determines the reference drive voltage phase θdrvR. At this time, the phase correction unit PHCP updates the magnitude of the correction value by feedback control so that the phase difference between the reference voltage phase θbemf and the reference current phase θi converges to zero. That is, in a feedback path, with the reference drive voltage phase θdrvR reflected, the drive current flows through the motor SPM, the drive current phase is detected by the drive current phase detection unit IPHD, the correction value is updated based on the detection result, and the reference drive voltage phase θdrvR is also updated.

Thereby, even if there occurs variation in the characteristic constants K1, K2 of the motor SPM, it is possible to accurately set the phase difference between the reference voltage phase θbemf and the reference current phase θi to zero. However, in the case of the occurrence of magnetization variation of the motor SPM, even if the BEMF phase and the drive current phase are in the state where the phase differences are zero in a phase, the BEMF phase and the drive current phase vary from zero in another phase, as shown in FIG. 21. If this variation is inappropriate, a large torque ripple might occur.

For this reason, the interphase phase variation correction unit PHDCP corrects the reference drive voltage phase θdrvR by reflecting each of the voltage phase errors (i.e., the phase error signal ECNT) in each of the three phases detected by the phase error detection unit PHED, and thereby determines the drive voltage phases θdrvU, θdrvV, θdrvW to the three phases. More specifically, for example, in the case of the u phase, the back electromotive force voltage phase detection unit BPHD of FIG. 2 detects the u-phase BEMF phase θbemf_U, and the phase error detection unit PHED detects the u-phase voltage phase error (Δθbemf_U (=θbemf−θbemf_U)).

The interphase phase variation correction unit PHDCP of FIG. 4 calculates a correction amount ΔθdrvU, for the reference drive voltage phase θdrvR, which is necessary to set, as the u-phase drive current phase, a phase shift amount (Δθi_U (=−Δθbemf_U)) opposite in direction and equal in amount to the u-phase voltage phase error (Δθbemf_U). Further, the interphase phase variation correction unit PHDCP adds the correction amount ΔθdrvU to the reference drive voltage phase θdrvR, and thereby generates the u-phase drive voltage phase θdrvU.

<<Configurations and Operations of Rotational Position Detection Unit and Phase Error Detection Unit>>

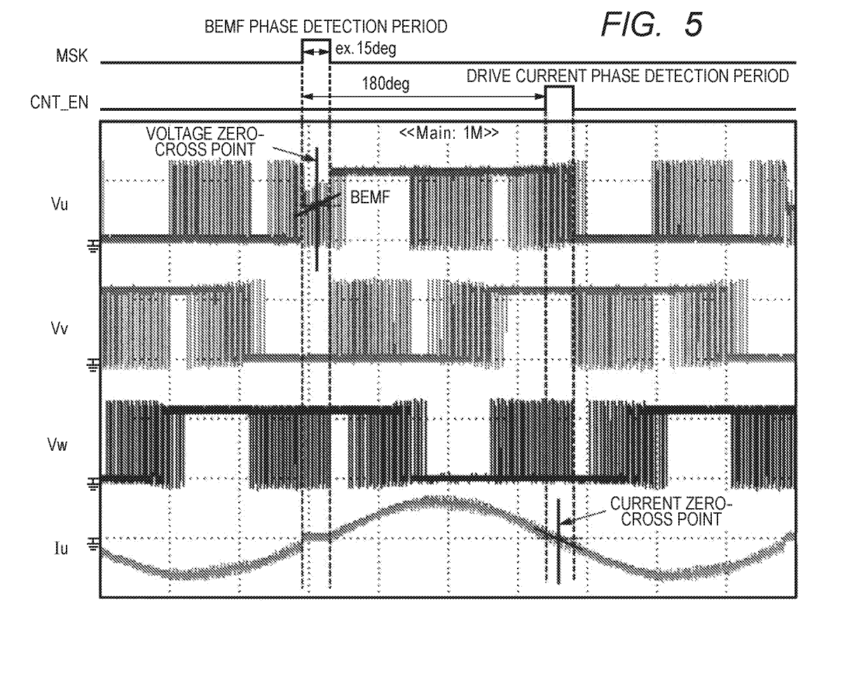

FIG. 5 is a waveform diagram showing an example of a detection period of the rotational position detection unit and the phase error detection unit in FIG. 2. FIG. 5 shows the drive voltages Vu, Vv, Vw of the respective phases applied to the motor SPM and the drive current Iu of a predetermined phase (the u phase in FIG. 5). The drive voltages Vu, Vv, Vw are PWM signals at each time point as shown in FIG. 5, and have voltage waveforms as shown in FIG. 20 by the time average.

The inverter unit INVBK of FIG. 18 applies the drive voltages Vu, Vv, Vw to the motor by a 180-degree conduction system without a non-conduction period, based on the driving method shown in FIG. 20. In this case, for example, to detect the u-phase BEMF phase, it is necessary to provide a non-conduction period in a predetermined period including the voltage zero-cross point (the time point of passing through the intermediate value of an amplitude) of the BEMF. For this reason, the PWM modulation unit PWMMD provides a non-conduction period (e.g., about 15 degrees) within the 360-degree conduction period by asserting the high impedance control signal HIZu, and asserts the mask signal MSK during the non-conduction period as shown in FIG. 5. The phase error detection unit PHED takes in the zero-cross detection signal ZXOUT from the back electromotive force voltage phase detection unit BPHD during the assertion period of the mask signal MSK, and detects the phase error of the u-phase BEMF phase.

Although not restricted, the PWM modulation unit PWMMD asserts a drive current detection enable signal CNT_EN in a conduction period that is 180 degrees out of phase with the non-conduction period, as shown in FIG. 5. The assertion period of the drive current detection enable signal CNT_EN is, for example, the same length (e.g., about 15 degrees) as the above-described non-conduction period. The drive current phase detection unit IPHD detects the current zero-cross point of the drive current Iu in the assertion period of the drive current detection enable signal CNT_EN, and determines the reference current phase θi based on the detection result.

As described above, the PWM modulation unit PWMMD controls conduction to the motor SPM, based on the conduction timing signal TIM synchronized with the BEMF from the PLL control unit PLLCT. Based on the conduction timing signal TIM, the PWM modulation unit PWMMD can narrow a period when the voltage zero-cross point of the BEMF of each phase can exist in the immediate future down to a sufficiently narrow range (e.g., 60 degrees or less, preferably about 15 degrees or less), and generates the mask signal MSK during the narrowed period. Since the non-conduction period is a factor distorting the sine wave of the drive current, it is preferable to make the non-conduction period shorter. However, too short a period causes non-existence of the voltage zero-cross point within the period due to fluctuation in the angular velocity ω of the motor SPM; therefore, the non-conduction period is determined by a trade-off therebetween.

<<Details of Back Electromotive Force Voltage Phase Detection Unit and Phase Error Detection Unit>>

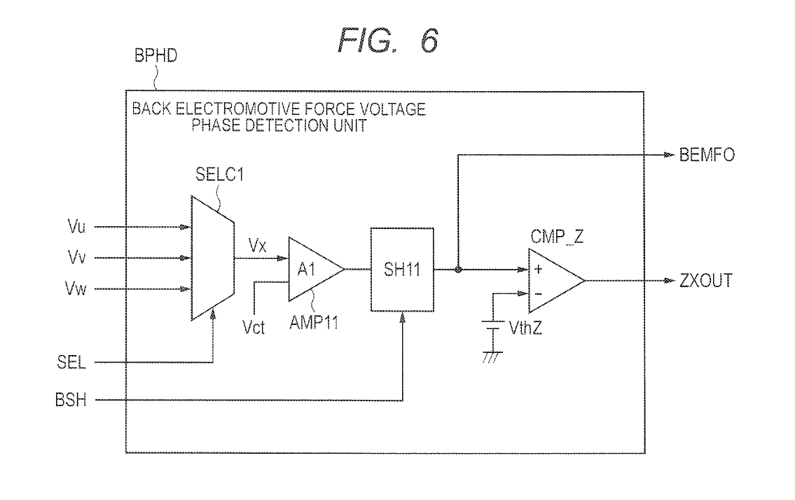

FIG. 6 is a circuit diagram showing a detailed configuration example of the back electromotive force voltage phase detection unit in FIG. 2. The back electromotive force voltage phase detection unit BPHD of FIG. 6 includes a selection circuit SELC1, an amplifier circuit AMP11, a sample hold circuit SH11, and a comparator circuit CMP_Z. The selection circuit SELC1 selects one of the three-phase drive voltages Vu, Vv, Vw based on the phase selection signal SEL, and outputs a drive voltage Vx of the selected phase. The amplifier circuit AMP11 amplifies the drive voltage Vx of the selected phase, with respect to a voltage Vct of the neutral point CT.

The sample hold circuit SH11 samples and holds the output voltage of the amplifier circuit AMP11, in accordance with a sampling signal BSH. The comparator circuit CMP_Z performs the transition of the logic level of the zero-cross detection signal ZXOUT when a back electromotive force voltage amplitude (referred to as a BEMF amplitude in this specification) BEMFO which is the output voltage of the amplifier circuit AMP11 reaches a zero-cross voltage VthZ (e.g., half of the power supply voltage VM of the motor). The sampling signal BSH and the phase selection signal SEL are generated by the PWM modulation unit PWMMD. The sampling signal BSH is generated every PWM cycle, and generated in a period when the high side transistor of one of the two phases other than the selected phase and the low side transistor of the other phase are both ON (i.e., a period when the voltage Vct is half the power supply voltage VM) in each PWM cycle.

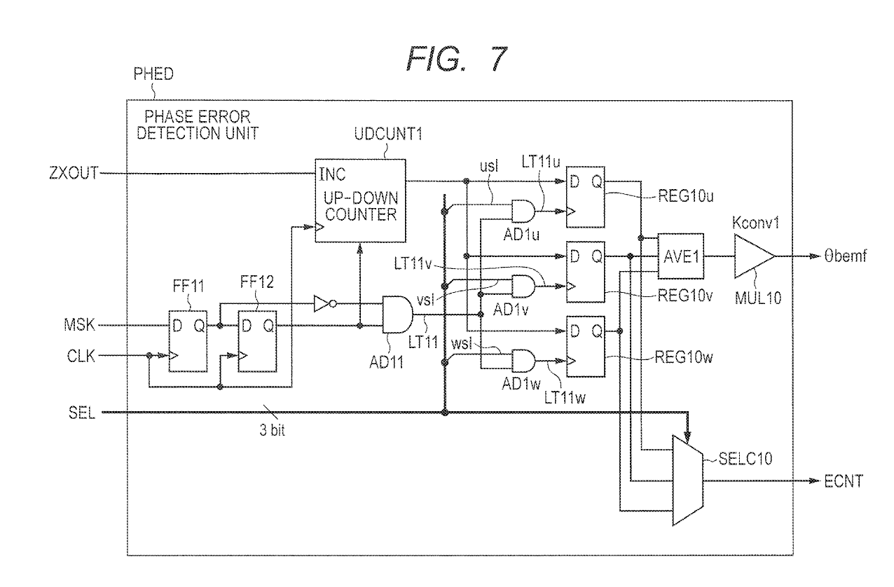

FIG. 7 is a circuit diagram showing a detailed configuration example of the phase error detection unit in FIG. 2. The phase error detection unit PHED of FIG. 7 includes flip-flop circuits FF11, FF12, an up-down counter circuit UDCUNT1, AND operation circuits AD11, AD1u, AD1v, AD1w, register circuits REG10u, REG10v, REG10w, an averaging circuit AVE1, a multiplication circuit MUL10, and a selection circuit SELC10.

The flip-flop circuits FF11, FF12 sequentially latch the mask signal MSK by a reference clock CLK of digital control, and outputs the resulting data to the up-down counter circuit UDCUNT1. The up-down counter circuit UDCUNT1 is brought into an enable state during the assertion period of the mask signal MSK, and performs a count operation based on the zero-cross detection signal ZXOUT in the enable state. More specifically, the up-down counter circuit UDCUNT1 performs count-up by the reference clock CLK in the case of one of the logic levels of the zero-cross detection signal ZXOUT, and performs count-down by the reference clock CLK in the case of the other logic level.

The AND operation circuit AD11 performs an AND operation, with the inverted output of the flip-flop circuit FF11 and the output of the flip-flop circuit FF12 as inputs, and thereby outputs a latch signal LT11 which is a one-shot pulse signal when the mask signal MSK transitions from the assertion period to a negation period. The AND operation circuits AD1u, AD1v, AD1w perform AND operations, with signals usl, vsl, wsl configuring the phase selection signal SEL and the latch signal LT11 as two inputs, respectively, and output latch signals LT11u, LT11y, LT11w to the register circuits REG10u, REG10v, REG10w.

The register circuits REG10u, REG10v, REG10w latch the count values of the up-down counter circuit UDCUNT1, with the latch signals LT11u, LT11y, LT11w as triggers, respectively. The averaging circuit AVE1 averages the count values of the register circuits REG10u, REG10v, REG10w. The multiplication circuit MUL10 multiplies the output of the averaging circuit AVE1 by a predetermined parameter Kconv1, and thereby outputs the reference voltage phase θbemf. The gain Kconv1 is a coefficient for converting the count value into the phase. The selection circuit SELC10 outputs one of the count values of the register circuits REG10u, REG10v, REG10w as the phase error signal ECNT, based on the phase selection signal SEL.

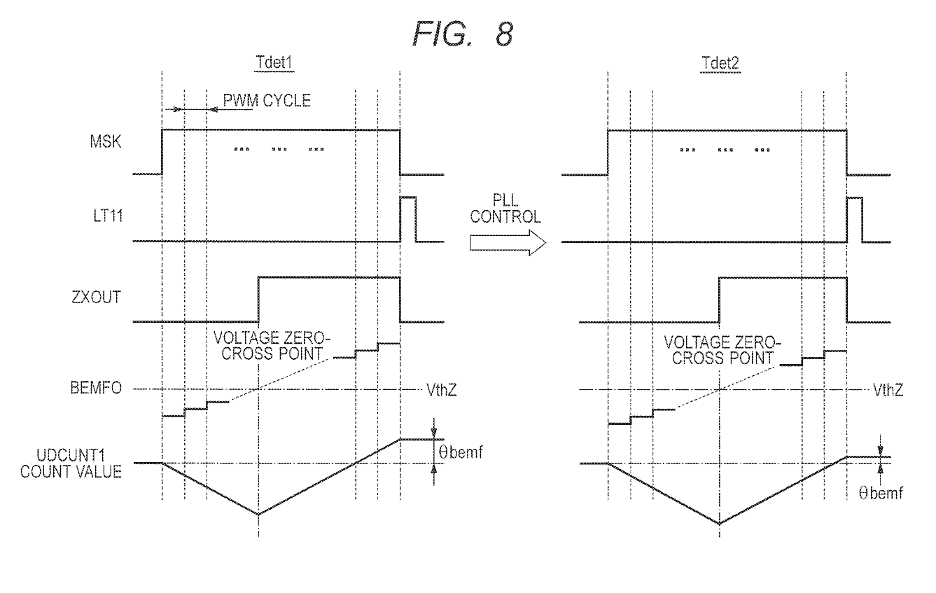

FIG. 8 is an explanation diagram showing a schematic operation example of the back electromotive force voltage phase detection unit of FIG. 6 and the phase error detection unit of FIG. 7. As shown in FIG. 8, when the mask signal MSK is asserted, the up-down counter circuit UDCUNT1 starts the count operation. In this example, the BEMF amplitude BEMFO from the sample hold circuit SH11 is smaller than the zero-cross voltage VthZ at the start of the count operation, then reaches the zero-cross voltage VthZ, and further rises above the zero-cross voltage VthZ.

In accordance therewith, the up-down counter circuit UDCUNT1 performs count-down until the BEMF amplitude BEMFO reaches the zero-cross voltage VthZ (i.e., until the zero-cross detection signal ZXOUT transitions), and performs count-up after BEMFO exceeds the zero-cross voltage VthZ (i.e., after ZXOUT transitions). Then, when the mask signal MSK is negated, the up-down counter circuit UDCUNT1 stops the count operation. The phase error detection unit PHED stores the final count value at the time of stopping the count operation in a register circuit corresponding to the selected phase among the register circuits REG10u, REG10v, REG10w.

As seen in FIG. 8, if the voltage zero-cross point exists at the intermediate time of the assertion period of the mask signal MSK, the final count value of the up-down counter circuit UDCUNT1 becomes zero. On the other hand, if the voltage zero-cross point is shifted from the intermediate time, the final count value of the up-down counter circuit UDCUNT1 becomes a value reflecting the direction and amount of the shift (in other words, the voltage phase error of the intermediate time).

For example, assume that the back electromotive force voltage phase detection unit BPHD and the phase error detection unit PHED are operated while sequentially switching the selected phase by the phase selection signal SEL. In this case, on the premise of a mask period MSK, the phase error detection unit PHED stores the three-phase voltage phase errors in the register circuits REG10u, REG10v, REG10w, respectively, and outputs the average value thereof as the reference voltage phase θbemf.

As described above, the PLL control unit PLLCT of FIG. 2 generates the conduction timing signal TIM which transitions periodically, and controls the phase of the conduction timing signal TIM by the PLL so that the phase difference between the phase thereof and the reference voltage phase θbemf converges to zero. The mask period MSK from the PWM modulation unit PWMMD is determined in the range of a predetermined electrical angle (e.g., 15 degrees) on the basis of the conduction timing signal TIM, and updated in accordance with the conduction timing signal TIM. The phase error detection unit PHED updates the reference voltage phase θbemf, on the premise of the updated mask period MSK.

By this feedback control, the PLL control unit PLLCT adjusts the window position of the mask period MSK through the phase control of the conduction timing signal TIM so that the reference voltage phase θbemf converges to zero, as shown by a period Tdet1→a period Tdet2. In other words, the PLL control unit PLLCT controls the phase of the conduction timing signal TIM so that the average timing of the voltage zero-cross points of the phases matches the intermediate time of the mask period MSK.

As a result, in a steady state, the reference voltage phase θbemf becomes substantially zero, and the register circuits REG10u, REG10v, REG10w in FIG. 7 each store the count value representing the voltage phase error from the reference voltage phase θbemf (≈0). Therefore, by controlling the selection circuit SELC10 by the phase selection signal SEL, it is possible to output the count value representing the voltage phase error (Δθbemf_U,V,W) of each phase as the phase error signal ECNT.

<<Details of Drive Current Phase Detection Unit>>

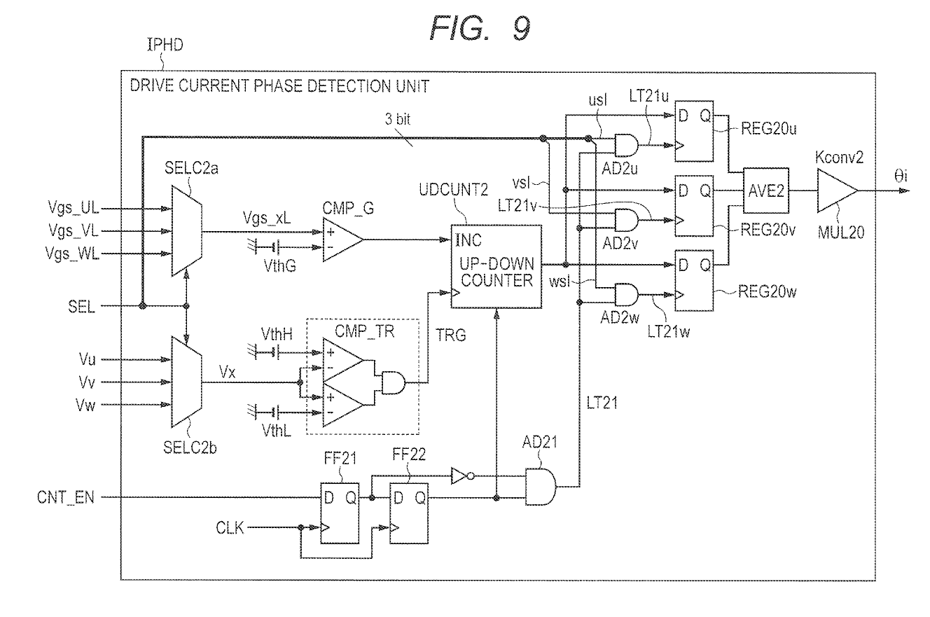

FIG. 9 is a circuit diagram showing a detailed configuration example of the drive current phase detection unit in FIG. 2. The drive current phase detection unit IPHD of FIG. 9 includes selector circuits SELC2a, SELC2b, comparator circuits CMP_G, CMP_TR, an up-down counter circuit UDCUNT2, flip-flop circuits FF21, FF22, and an AND operation circuit AD21. Further, the drive current phase detection unit IPHD includes AND operation circuits AD2u, AD2v, AD2w, register circuits REG20u, REG20v, REG20w, an averaging circuit AVE2, and a multiplication circuit MUL20, as in the configuration example of FIG. 7.

The selector circuit SELC2a receives the gate-source voltages Vgs_UL, Vgs_VL, Vgs_WL of the three-phase low side transistors M2u, M2v, M2w, selects one of them based on the phase selection signal SEL, and outputs it to the comparator circuit CMP_G as a gate-source voltage Vgs_xL. Similarly, the selector circuit SELC2b selects one of the three-phase drive voltages Vu, Vv, Vw based on the phase selection signal SEL, and outputs it to the comparator circuit CMP_TR as the drive voltage Vx.

The comparator circuit CMP_G performs a magnitude comparison between the gate-source voltage Vgs_xL from the selector circuit SELC2a and a predetermined threshold voltage VthG. That is, the comparator circuit CMP_G determines whether the low side transistor of the selected phase is ON or OFF. The comparator circuit CMP_TR determines whether or not the drive voltage Vx from the selector circuit SELC2b is in a range larger than a low potential side threshold voltage VthL and smaller than a high potential side threshold voltage VthH. That is, the comparator circuit CMP_TR detects a period when the drive voltage Vx transitions between the high potential side power supply voltage VM and the low potential side power supply voltage (ground power supply voltage GND) in accordance with the PWM signal. The comparator circuit CMP_TR asserts a trigger signal TRG in the detected transition period.

The flip-flop circuits FF21, FF22 sequentially latch the drive current detection enable signal CNT_EN by the reference clock CLK of digital control, and outputs the resulting data to the up-down counter circuit UDCUNT2. The up-down counter circuit UDCUNT2 is brought into an enable state during the assertion period of the drive current detection enable signal CNT_EN. In the enable state, the up-down counter circuit UDCUNT2 performs count-down or count-up, based on the comparison result of the comparator circuit CMP_G, every time the trigger signal TRG is asserted. For example, the up-down counter circuit UDCUNT2 performs count-down if Vgs_xL<VthG (the low side transistor of the selected phase is OFF), and performs count-up if Vgs_xL>VthG (the low side transistor of the selected phase is ON).

The AND operation circuit AD21 performs an AND operation, with the inverted output of the flip-flop circuit FF21 and the output of the flip-flop circuit FF22 as inputs, and thereby outputs a latch signal LT21 which is a one-shot pulse signal when the drive current detection enable signal CNT_EN transitions from the assertion period to a negation period. The AND operation circuits AD2u, AD2v, AD2w perform AND operations, with selection signals usl, vsl, wsl and the latch signal LT21 as two inputs, respectively, and output latch signals LT21u, LT21v, LT21w to the register circuits REG20u, REG20v, REG20w.

The register circuits REG20u, REG20v, REG20w receive the latch signals LT21u, LT21v, LT21w, and latch the count values from the up-down counter circuit UDCUNT2, respectively, and the averaging circuit AVE2 averages the count values. The multiplication circuit MUL20 amplifies the output of the averaging circuit AVE2 by a predetermined gain Kconv2, and thereby outputs the reference current phase θi. The gain Kconv2 is a coefficient for converting the count value into the phase.

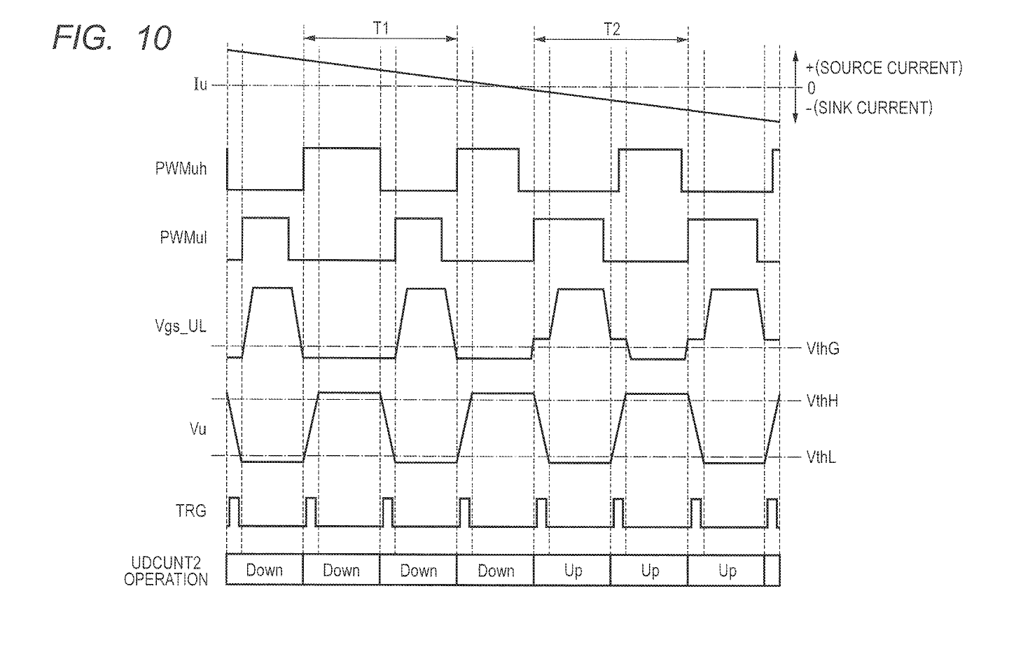

FIG. 10 is a waveform diagram showing the operating principle of the drive current phase detection unit of FIG. 9. FIG. 10 shows, for example, the schematic operating waveform of each signal when the drive current Iu changes from a source current (plus current) to a sink current (minus current). A regenerative current associated with PWM control flows through the u-phase low side transistor M2u during a period when the source current flows, and a drive current associated with PWM control flows through the u-phase low side transistor M2u during a period when the sink current flows.

By the difference between the regenerative current and the drive current, as shown in FIG. 10, in a period when the drive voltage Vu transitions in a PWM cycle T1 during which the drive current Iu is the source current, the gate-source voltage Vgs_UL of the low side transistor M2u becomes smaller than the predetermined threshold voltage VthG. That is, the low side transistor M2u is turned off. On the other hand, in a period when the drive voltage Vu transitions in a PWM cycle T2 during which the drive current Iu is the sink current, the gate-source voltage Vgs_UL of the low side transistor M2u becomes larger than the predetermined threshold voltage VthG. That is, the low side transistor M2u is turned on.

Thus, in the period when the drive voltage Vu of the selected phase (the u phase in FIG. 10) of the motor SPM transitions, the drive current phase detection unit IPHD of FIG. 9 determines whether the low side transistor M2u of the selected phase is ON or OFF, and thereby determines whether the current of the selected phase is the source current or the sink current. Further, the drive current phase detection unit IPHD detects, as the current zero-cross point of the drive current Iu, a time point when one of the source current and the sink current is switched to the other.

More specifically, as shown in FIG. 10, the up-down counter circuit UDCUNT2 of the drive current phase detection unit IPHD performs count-down if it is determined that the drive current is the source current, and performs count-up if it is determined that the drive current is the sink current. Although not shown in FIG. 10, the up-down counter circuit UDCUNT2 performs this count operation during the assertion period of the drive current detection enable signal CNT_EN, as with the mask signal MSK. As a result, as in FIG. 8, the drive current phase detection unit IPHD determines the reference current phase θi, based on the final count value when the drive current detection enable signal CNT_EN is negated. For example, in the case where the drive current phase detection unit IPHD is operated while sequentially switching the selected phase by the phase selection signal SEL, the average phase of the phases is determined as the reference current phase θi.

While the phase error detection unit PHED of FIG. 7 and the drive current phase detection unit IPHD of FIG. 9 determine the respective average phases of the phases to be the reference voltage phase θbemf and the reference current phase θi, the respective representative phases instead of the average phases may be determined to be the reference voltage phase θbemf and the reference current phase θi. For example, the phase error detection unit PHED may determine the u-phase BEMF phase to be the reference voltage phase θbemf, and the drive current phase detection unit IPHD may determine the u-phase drive current phase to be the reference current phase θi.

<<Details of Drive Voltage Phase Generation Unit>>

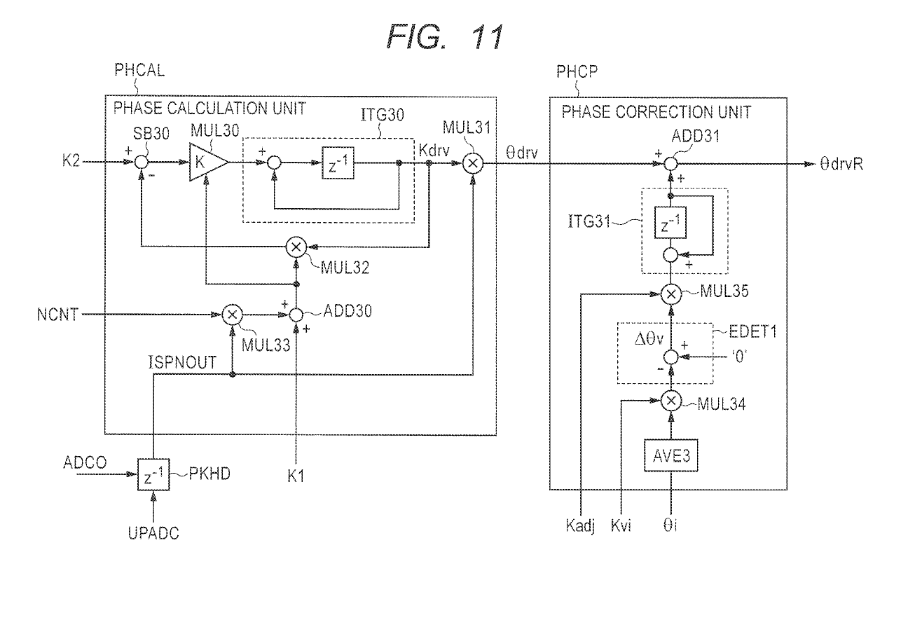

FIG. 11 is a diagram showing a detailed configuration example of the phase calculation unit and the phase correction unit in the drive voltage phase generation unit of FIG. 4. As shown in the vector diagram of FIG. 23A, to set the phase difference between the phase of the back electromotive force voltage Vbemf (in other words, the reference voltage phase θbemf) and the phase of the coil current Icoil (in other words, the reference current phase θi) to zero, it is necessary to advance the phase of the drive voltage Vdrv by the drive voltage phase θdrv with respect to the reference voltage phase θbemf.

The drive voltage phase θdrv is expressed by an equation (1), using the angular frequency ω and torque constant Ke of the motor SPM. In the equation (1), “ω·Ke” corresponds to the back electromotive force voltage Vbemf of FIG. 23A.

θdrv=tan⁻¹ {ω·Lm·Icoil/(ω·Ke+Rm·Icoil)} (1)

The drive voltage phase θdrv is generally a sufficiently small value. In this case, “tan⁻¹” can be omitted by using the approximation of an equation (2), and an equation (3) can be obtained by modifying the omitted equation.

θdrv≈tan⁻(θdrv) (2)

θdrv=(Lm/Rm)·Icoil/{(Ke/Rm)+(Icoil/ω)} (3)

The phase calculation unit PHCAL shown in FIG. 11 calculates the drive voltage phase θdrv, based on the equation (3). More specifically, in the equation (3), a value corresponding to “Ke/Rm” is determined by the characteristic constant K1, a value corresponding to “Lm/Rm” is determined by the characteristic constant K2, a value corresponding to “Icoil” is determined by the drive current amplitude ISPNOUT from the peak storage unit PKHD, and a value corresponding to “1/ω” is determined by the rotation cycle count value NCNT. In this case, the equation (3) becomes the equation (4), and the drive voltage phase θdrv is obtained by multiplying “Kdrv” in an equation (5) by “ISPNOUT”.

θdrv=K2·ISPNOUT/(K1+ISPNOUT·NCNT) (4)

Kdrv=K2/(K1+ISPNOUT·NCNT) (5)

The phase calculation unit PHCAL shown in FIG. 11 includes a subtractor SB30, multipliers MUL30 to MUL33, an integrator ITG30, and an adder ADD30. The multiplier MUL33 calculates “NCNT·ISPNOUT”, and the adder ADD30 adds “K1” to the output of the multiplier MUL33, thereby calculating the denominator of the equation (5). The multiplier MUL32 multiplies the output of the adder ADD30 by “Kdrv”. The subtractor SB30 calculates an error between the multiplication result of the multiplier MUL32 and “K2”, the multiplier MUL30 amplifies the error by an integration gain K, and the integrator ITG30 integrates the multiplication result of the multiplier MUL30, and thereby calculates “Kdrv” of the equation (5).

That is, the phase calculation unit PHCAL of FIG. 11 includes a calculation circuit for calculating “Kdrv” by feedback-controlling “Kdrv” so that the error between the multiplication result (i.e., “Kdrv·(K1+ISPNOUT·NCNT)”) of the multiplier MUL32 and “K2” converges to zero. When the error converges to zero, “Kdrv·(K1+ISPNOUT·NCNT)” becomes equal to “K2”; consequently, “Kdrv” becomes the value of the equation (5). The multiplier MUL31 multiplies “Kdrv” by “ISPNOUT”, and thereby calculates the phase θdrv of the equation (4).

Thus, by using the calculation circuit using feedback control, it is possible to calculate the equation (4) without using a divider which possibly has a complicated configuration and to simplify the circuit configuration. In the configuration shown in FIG. 11, the multiplier MUL30 variably controls the integration gain K in accordance with the calculation result of the adder ADD30. More specifically, for example, the integration gain K is controlled so as to decrease stepwise as the output of the adder ADD30 increases. Thereby, it is possible to maintain the bandwidth of feedback control at almost the same level, regardless of the magnitude of the output of the adder ADD30.

The phase correction unit PHCP shown in FIG. 11 includes an averaging circuit AVE3, multipliers MUL34, MUL35, an error detector EDET1, an integrator ITG31, and an adder ADD31. The averaging circuit AVE3 time-sequentially averages inputted reference current phases θi. The multiplier MUL34 multiplies the averaged reference current phase θi by the gain adjustment parameter Kvi. The error detector EDET1 detects a phase error Δθv of the multiplication result of the multiplier MUL34, aiming at the zero phase. That is, as described with FIG. 8, the reference voltage phase θbemf becomes zero in the steady state, and the phase error between the reference voltage phase θbemf of zero and the actual reference current phase θi is ‘Δθv’.

The multiplier MUL35 multiplies the detection result (Δθv) of the error detector EDET1 by the gain adjustment parameter (i.e., the integration gain) Kadj, and the integrator ITG31 integrates the multiplication result of the multiplier MUL35, and thereby calculates a correction value. The adder ADD31 adds the correction value calculated by the integrator ITG31 to the drive voltage phase θdrv from the phase calculation unit PHCAL, and thereby calculates the reference drive voltage phase θdrvR. The gain adjustment parameter Kvi is a coefficient for adjusting the sensitivity of the reference drive voltage phase θdrvR to the change of the reference current phase θi.

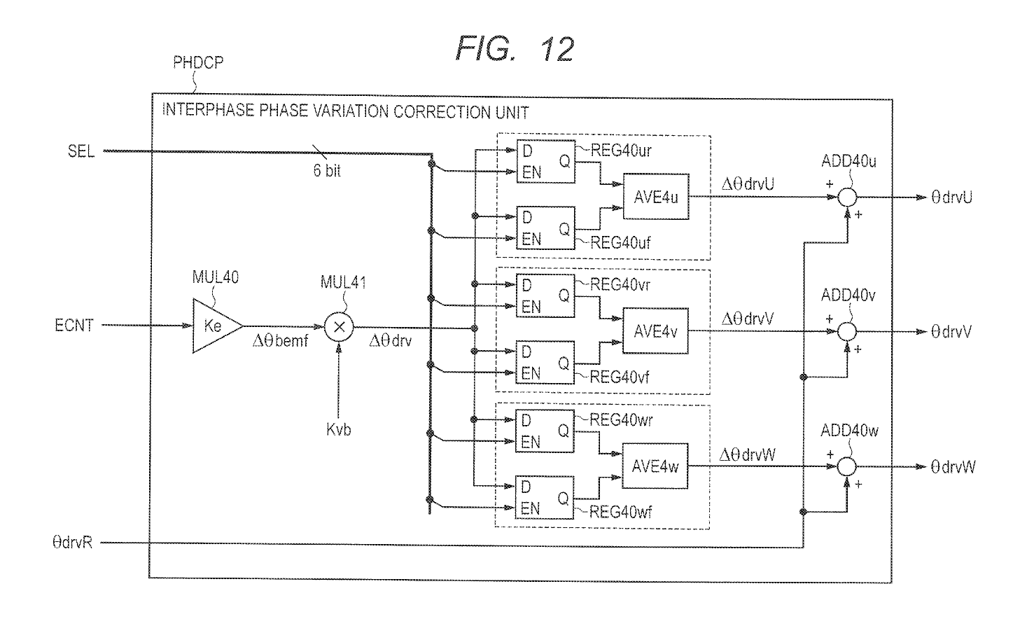

FIG. 12 is a diagram showing a detailed configuration example of the interphase phase variation correction unit in the drive voltage phase generation unit of FIG. 4. The interphase phase variation correction unit PHDCP of FIG. 12 includes multipliers MUL40, MUL41, register circuits REG40ur, REG40uf, REG40vr, REG40vf, REG40wr, REG40wf, averaging circuits AVE4u, AVE4v, AVE4w, and adders ADD40u, ADD40v, ADD40w.

The multiplier MUL40 multiplies the phase error signal ECNT as the count value from the phase error detection unit PHED by a phase error detection gain Ke. The phase error detection gain Ke is a coefficient for converting the count value into the phase. As a result, the multiplier MUL40 outputs one of the voltage phase errors Δθbemf_U,V,W in each of the three phases in accordance with the selected phase in the phase error detection unit PHED. The multiplier MUL41 multiplies one of the voltage phase errors Δθbemf_U,V,W in each of the three phases by a voltage phase adjustment gain parameter Kvb. The voltage phase adjustment gain parameter Kvb is an adjustment gain for calculating the correction amount for the drive voltage phase which is necessary to set the drive current phase according to the voltage phase error of the BEMF phase, and is expressed by an equation (8).

$$\begin{matrix} {θ}_{drv} = {tan}^{- 1} \frac{{V}_{bemf} \cdot sin {Δθ}_{bemf} + {Z}_{m} \cdot {I}_{coil} \cdot sin ( {Δθ}_{i} + {θ}_{coil} )}{{V}_{bemf} \cdot cos {Δθ}_{bemf} + {Z}_{m} \cdot {I}_{coil} \cdot cos ( {Δθ}_{i} + {θ}_{coil} )} & ( 6 ) \\ {θ}_{drv} = {tan}^{- 1} \frac{{V}_{bemf} \cdot sin {Δθ}_{bemf} + {Z}_{m} \cdot {I}_{coil} \cdot sin ( - {Δθ}_{bemf} + {θ}_{coil} )}{{V}_{bemf} \cdot cos {Δθ}_{bemf} + {Z}_{m} \cdot {I}_{coil} \cdot cos ( - {Δθ}_{bemf} + {θ}_{coil} )} & ( 7 ) \\ \frac{d {θ}_{drv}}{d ( {Δθ}_{bemf} )} = \frac{{V}_{bemf}^{2} - {Z}_{m}^{2} \cdot {I}_{coil}^{2}}{{V}_{bemf}^{2} + {Z}_{m}^{2} \cdot {I}_{coil}^{2} + 2 {V}_{bemf} \cdot {Z}_{m} \cdot {I}_{coil} \cdot cos ( 2 {Δθ}_{bemf} - {θ}_{z} )} & ( 8 )\end{matrix}$$

With regard to the equation (8), first, referring to FIGS. 23B and 23C, the drive voltage phase θdrv in the case where the BEMF phase is shifted by Δθbemf and the drive current phase is shifted by Δθi is expressed by the equation (6), using the impedance component Zm (=Rm+j·ω·Lm) of the coil. In the equation (6), by setting Δθi=−Δθbemf, the equation (7) is obtained. The equation (7) is a relational expression between the BEMF phase and the drive voltage phase θdrv obtained in the state where the BEMF phase is shifted by Δθbemf and the drive current phase is shifted by the same amount as and in the opposite direction of the BEMF phase (i.e., Δθi=−Δθbemf) with respect to the state where the BEMF phase and the drive current phase match with each other. By differentiating the equation (7) with respect to Δθbemf, the equation (8) is obtained.

Thus, the voltage phase adjustment gain parameter Kvb of the equation (8) is a coefficient indicating the sensitivity of the drive current phase θdrv to the shift amount of the BEMF phase in the relational expression of the equation (7). In other words, the voltage phase adjustment gain parameter Kvb is a coefficient for calculating the correction amount Δθdrv(U,V,W), for the reference drive voltage phase θdrvR, which is necessary to construct the state of Δθi(U,V,W)=Δθbemf(U,V,W) in the case where the BEMF phase is shifted by Δθbemf(U,V,W).

The register circuit REG40ur stores a correction amount at the rise of the u phase from the multiplier MUL41 in accordance with the phase selection signal SEL, and the register circuit REG40uf stores a correction amount at the fall of the u phase from the multiplier MUL41 in accordance with the phase selection signal SEL. Similarly, the register circuits REG40vr, REG40vf store correction amounts at the rise and fall of the v phase respectively, and the register circuits REG40wr, REG40wf store correction amounts at the rise and fall of the w phase respectively.

In this example, the PWM modulation unit PWMMD of FIG. 2 detects voltage zero-cross points at the rises and falls of the three-phase BEMFs respectively, and sequentially outputs six mask signals MSK of mutually different electrical angle positions. More specifically, for example, the PWM modulation unit PWMMD cyclically performs the operation of outputting one of the six mask signals MSK in a period and outputting another one in the next period. Further, the PWM modulation unit PWMMD outputs, in parallel with the output of the mask signal MSK, the phase selection signal SEL indicating which of the six mask signals MSK is the present mask signal MSK.

The averaging circuit AVE4u averages the output values of the register circuits REG40ur, REG40uf, and thereby calculates the u-phase correction amount ΔθdrvU. The adder ADD40u adds the u-phase correction amount ΔθdrvU to the reference drive voltage phase θdrvR, and thereby generates the u-phase drive voltage phase θdrvU. Similarly, the averaging circuit AVE4v calculates the v-phase correction amount ΔθdrvV based on the register circuits REG40vr, REG40vf, and the averaging circuit AVE4w calculates the w-phase correction amount ΔθdrvW based on the register circuits REG40wr, REG40wf. The adders ADD40v, ADD40w add the correction amounts ΔθdrvV, ΔθdrvW of the v phase and the w phase to the reference drive voltage phase θdrvR, and thereby generate the drive voltage phases θdrvV, θdrvW of the v phase and the w phase, respectively.

Thus, by using the motor drive device and the motor system according to the first embodiment, for example, even in the presence of magnetization variation of the motor SPM, it is possible to reduce the torque ripple of the motor SPM. As a result, it is possible to reduce the vibration and noise of the motor SPM. Further, it is possible to relieve requirements for the manufacturing process (processing accuracy, assembling accuracy, etc.) of the motor SPM and therefore reduce the cost of the motor SPM.

In practical use, the drive voltage phase generation unit DVPHG does not need to operate at all times, but can operate, for example, when the motor system is started or when external environment is changed. That is, the reference drive voltage phase θdrvR and the drive voltage phases θdrvU,V,W according to magnetization variation normally do not change in a time series manner but can be continuously used for a certain period of time once they are set appropriately, in the nature thereof. Therefore, in practical use, the motor drive device MDIC determines the reference drive voltage phase θdrvR and the drive voltage phases θdrvU,V,W while appropriately changing the phase to be set to high impedance at the startup of the motor system for example, and then can drive the motor SPM, using the determined values, without particularly performing high impedance setting.

### Second Embodiment

<<Problem of Motor Drive Device (Comparative Example)>>

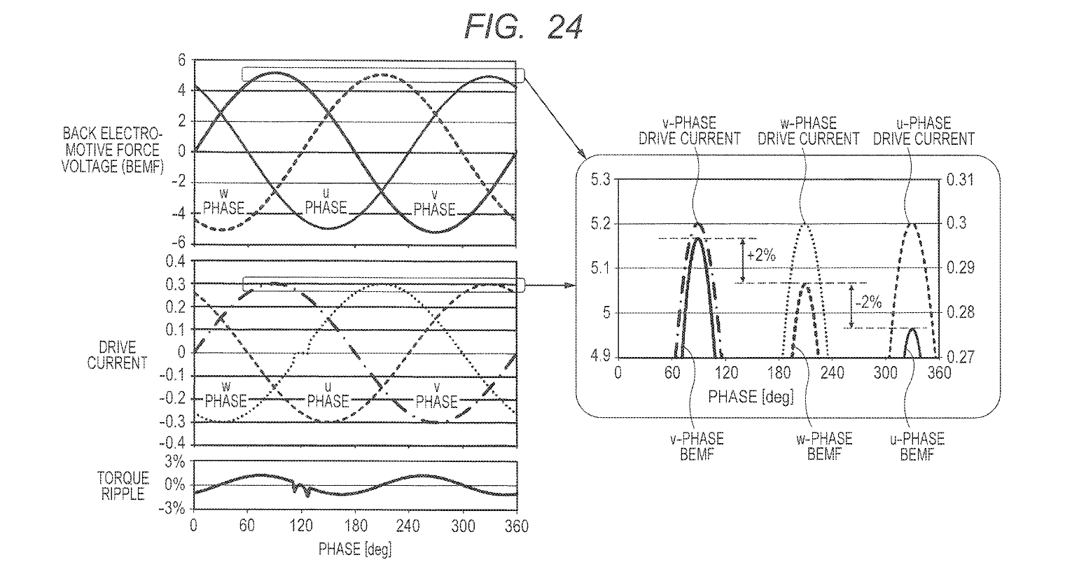

FIG. 24 is a waveform diagram showing an example of the back electromotive force voltage, drive current, and torque ripple of the motor in the case where the motor drive device of FIG. 17 drives the motor. The back electromotive force voltage amplitudes (BEMF amplitudes) in the case of using the ideal motor SPM are the same amplitude of the sine wave voltage among the u phase, the v phase, and the w phase. However, the BEMF amplitudes in the case of using an actual motor SPM might vary with respect to the BEMF amplitude in the case of using the ideal motor SPM, as shown in FIG. 24.

In the example of FIG. 24, the BEMF amplitudes of the u phase, the v phase, and the w phase are decreased by 2%, increased by 2%, and not varied, with respect to the BEMF amplitude of the ideal motor SPM, respectively. Such interphase variation of the BEMF amplitude is also referred to as magnetization variation, and is mainly caused by the structure of the motor SPM. Variation factors include, for example, inductance variation of the coil of each phase in a stator and characteristic variation of a magnet in a rotor.

On the other hand, on the premise of the ideal motor, the motor drive device shown in FIG. 17 applies the drive voltage of the same amplitude reflecting the current instruction value SPNCR_R to the three phases, and thereby feeds the drive current of the same amplitude to the three phases. If, in the state of different BEMF amplitudes, the drive current amplitudes of the phases are equally controlled, the torques of the phases are different, so that the torque ripple increases, which might increase noise and vibration in motor drive.

### Schematic Configuration and Schematic Operation of Motor Drive Device (Second Embodiment)

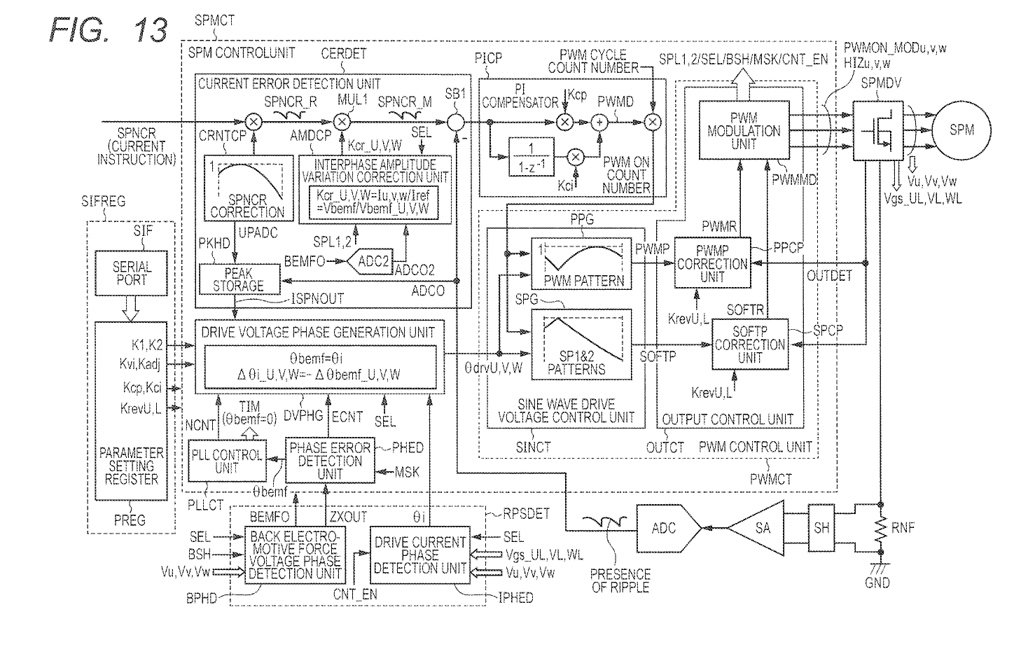

FIG. 13 is a functional block diagram showing a configuration example of the main part of a motor drive device according to the second embodiment of the present invention. In comparison with the configuration example of FIG. 2, the motor drive device MDIC shown in FIG. 13 additionally includes an analog-digital converter ADC2, an interphase amplitude variation correction unit AMDCP, and a multiplier MUL1 in the current error detection unit CERDET. The back electromotive force voltage phase detection unit BPHD shown in FIG. 6 also functions as a back electromotive force voltage amplitude detection unit for detecting each of the three-phase BEMF amplitudes BEMFO in accordance with the phase selection signal SEL.

The analog-digital converter ADC2 converts the three-phase BEMF amplitudes BEMFO from the back electromotive force voltage phase detection unit (in other words, the back electromotive force voltage amplitude detection unit) BPHD into digital values ADCO2. The interphase amplitude variation correction unit AMDCP determines one of drive voltage amplitudes in each of the three phases at the time of applying the drive voltages so that the three-phase drive current amplitudes have amplitude variation that is the reciprocal of relative amplitude variation of the three-phase BEMF amplitudes.

For example, ‘Vbemf’ denotes the average or representative BEMF amplitude of the three phases, ‘Iref’ denotes a reference drive current amplitude on the basis of the current instruction value SPNCR_R, and ‘Vbemf_U’, ‘Vbemf_V’, ‘Vbemf_W’ denote the BEMF amplitudes BEMFO of the u phase, the v phase, and the w phase obtained by the digital values ADCO2, respectively. In this case, the amplitude variations of the BEMF amplitudes of the u phase, the v phase, and the w phase with respect to ‘Vbemf’ are expressed as ‘Vbemf_U/Vbemf’, ‘Vbemf_V/Vbemf’, ‘Vbemf_W/Vbemf’, respectively. Further, if ‘Iu’, ‘Iv’, ‘Iw’ denote the drive current amplitudes of the u phase, the v phase, and the w phase respectively, the amplitude variations of the drive current amplitudes of the u phase, the v phase, and the w phase with respect to ‘Iref’ are expressed as ‘Iu/Iref’, ‘Iv/Iref’, ‘Iw/Iref’, respectively.

The interphase amplitude variation correction unit AMDCP calculates a u-phase current correction coefficient Kcr_U so that the amplitude variation (Iu/Iref) of the u-phase drive current amplitude Iu is set to the reciprocal (i.e., Vbemf/Vbemf_U) of the amplitude variation (Vbemf_U/Vbemf) of the u-phase BEMF amplitude. The current correction coefficient Kcr_U represents a weight to ‘Iref’ (i.e., the current instruction value SPNCR_R). Further, the interphase amplitude variation correction unit AMDCP calculates a v-phase current correction coefficient Kcr_V and a w-phase current correction coefficient Kcr_W for the v phase and the w phase in the same way, respectively.

On the other hand, the sample hold circuit SH, the sense amplifier circuit SA, and the analog-digital converter ADC functions as a drive current amplitude detection unit for detecting each of the three-phase drive current amplitudes. More specifically, for example, in a period when the u-phase high side transistor M1u is ON and the high side transistors M1v, M1w of the v phase and w phase are both OFF, the drive current amplitude detection unit performs sampling by the sample hold circuit SH, and thereby detects the u-phase drive current amplitude. Similarly, in the v phase and w phase, the drive current amplitude detection unit appropriately controls sampling timings, and thereby detects the drive current amplitude of each phase.

The interphase amplitude variation correction unit AMDCP outputs the u-phase current correction coefficient Kcr_U in the period when the drive current amplitude detection unit detects the u-phase drive current amplitude. The multiplier MUL1 multiplies the current instruction value SPNCR_R by the current correction coefficient Kcr_U, and thereby outputs a current instruction value SPNCR_M (i.e., a u-phase current instruction value). The subtractor SB1 detects an error between the u-phase current instruction value SPNCR_M and the u-phase drive current amplitude represented by the digital value ADCO.

Similarly, in the v phase and w phase, the interphase amplitude variation correction unit AMDCP outputs the current correction coefficients Kcr_V, Kcr_W in the periods when the drive current amplitude detection unit detects the drive current amplitudes of the v phase and w phase, respectively. As a result, the subtractor SB1 detects an error between the current instruction value SPNCR_M of each phase and the drive current amplitude of each phase. The current correction coefficients Kcr_U, Kcr_V, Kcr_W to be outputted is selected by the phase selection signal SEL.

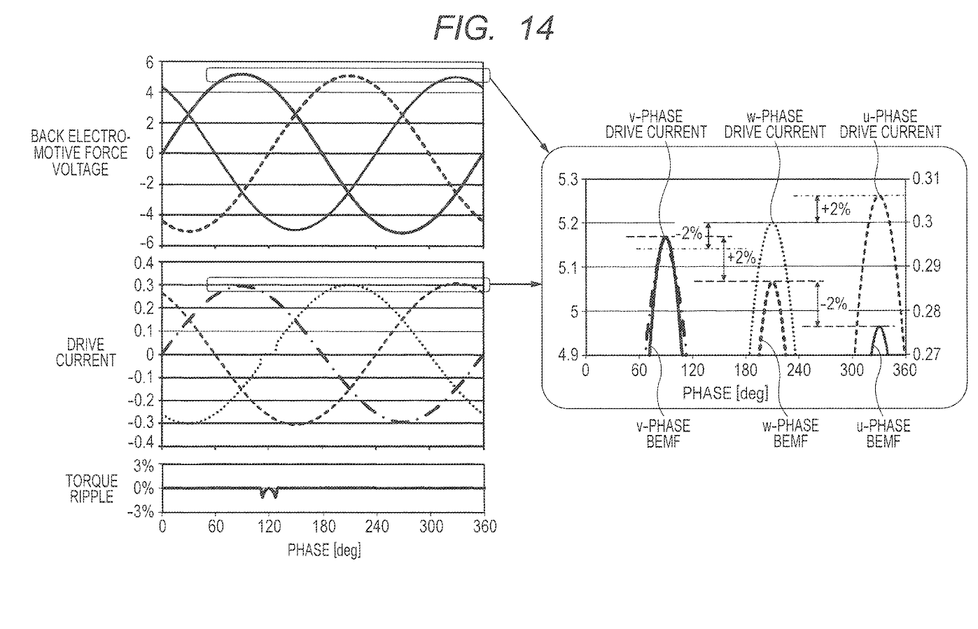

FIG. 14 is a waveform diagram showing an example of the back electromotive force voltage, drive current, and torque ripple of the motor in the case where the motor drive device of FIG. 13 drives the motor. In FIG. 14, in the three-phase back electromotive force voltage amplitudes (BEMF amplitudes), with respect to the w phase, the u phase is relatively smaller by 2%, and the v phase is relatively larger by 2%, as in FIG. 24. With the configuration example of FIG. 13, if the u-phase BEMF amplitude is smaller by 2% than the reference BEMF amplitude, the u-phase drive current amplitude is controlled so as to be larger by 2% than the reference drive current amplitude. Further, if the v-phase BEMF amplitude is larger by 2% than the reference BEMF amplitude, the v-phase drive current amplitude is controlled so as to be smaller by 2% than the reference drive current amplitude.

Thus, by controlling the drive current amplitude of each phase, even in the presence of magnetization variation of the motor SPM, it is possible to reduce the torque ripple and reduce vibration and noise in motor drive. Qualitatively, the torque of each phase is a function of “BEMF X drive current” as described with FIG. 3. Therefore, for example, if the BEMF amplitude of a phase varies to a K-fold amplitude, the drive current amplitude of the phase is corrected to a “1/K”-fold amplitude, thereby making it possible to keep the torque of each phase constant.

<<Details of Interphase Amplitude Variation Correction Unit>>

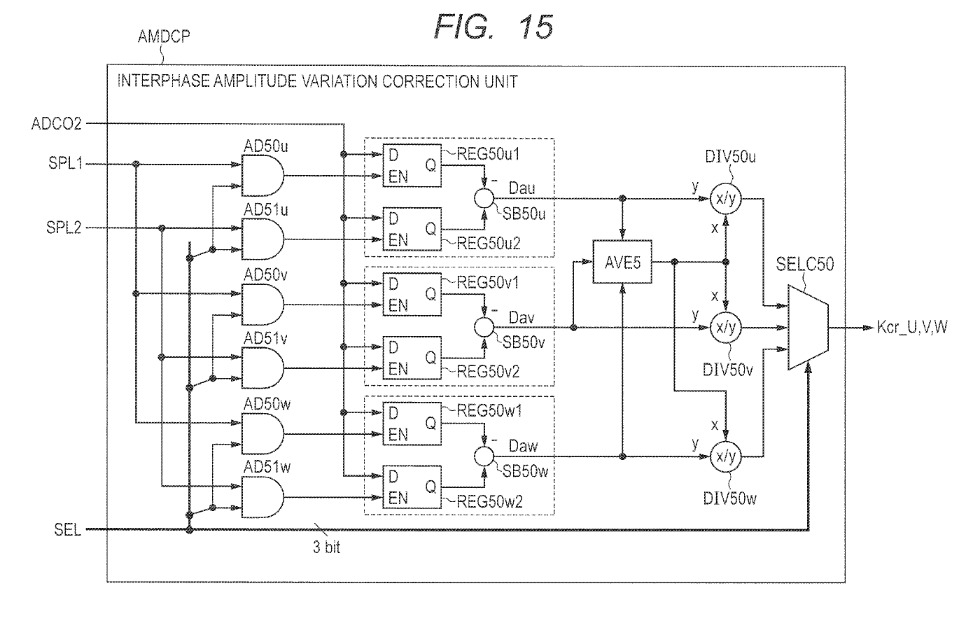

FIG. 15 is a diagram showing a detailed configuration example of the interphase amplitude variation correction unit in FIG. 13. The interphase amplitude variation correction unit shown in FIG. 15 has AND operation circuits AD50(u,v,w), AD51(u,v,w), register circuits REG50(u1,u2,v1,v2,w1,w2), subtractors SB50(u,v,w), an averaging circuit AVE5, dividers DIV50(u,v,w), and a selection circuit SELC50.

In the case where the phase selected by the phase selection signal SEL is the u phase, the output of the AND operation circuit AD50u is asserted during the assertion period of a sampling signal SPL1, and the output of the AND operation circuit AD51u is asserted during the assertion period of a sampling signal SPL2. Similarly, in the case where the selected phase is the v phase, the output of the AND operation circuit AD50v is asserted in accordance with the sampling signal SPL1, and the output of the AND operation circuit AD51v is asserted in accordance with the sampling signal SPL2. Further, in the case where the selected phase is the w phase, the output of the AND operation circuit AD50w is asserted in accordance with the sampling signal SPL1, and the output of the AND operation circuit AD51w is asserted in accordance with the sampling signal SPL2. The sampling signals SPL1, SPL2 are generated by the PWM modulation unit PWMMD of FIG. 13.

The register circuits REG50u1, REG50u2, REG50v1, REG50v2, REG50w1, REG50w2 latch the digital values ADCO2 from the analog-digital converter ADC2, in accordance with the assertion of the outputs of the AND operation circuits AD50u, AD51u, AD50v, AD51v, AD50w, AD51w, respectively. The subtractor SB50u calculates a difference value between the output value of the register circuit REG50u2 and the output value of the register circuit REG50u1, and outputs the difference value as a u-phase back electromotive force voltage amplitude Dau. Similarly, the subtractor SB50v calculates a difference value between the output values of the register circuits REG50v1 and REG50v2, and outputs it as a v-phase back electromotive force voltage amplitude Day. The subtractor SB50w calculates a difference value between the output values of the register circuits REG50w1 and REG50w2, and outputs it as a w-phase back electromotive force voltage amplitude Daw.

The averaging circuit (average value calculation unit) AVE5 calculates the average value of the back electromotive force voltage amplitudes Dau, Dav, Daw of the u-phase, the v-phase, and the w-phase. If ‘y’ denotes the u-phase back electromotive force voltage amplitude Dau (corresponding to Vbemf_U in FIG. 13) and ‘x’ denotes the average value (corresponding to Vbemf in FIG. 13) of the back electromotive force voltage amplitudes, the divider (amplitude ratio calculation unit) DIV50u calculates “x/y” and thereby determines the current correction coefficient Kcr_U. Similarly, the divider DIV50v calculates the ratio between the v-phase back electromotive force voltage amplitude Dav and the average value of the back electromotive force voltage amplitudes, and thereby determines the current correction coefficient Kcr_V. The divider DIV50w calculates the ratio between the w-phase back electromotive force voltage amplitude Daw and the average value of the back electromotive force voltage amplitudes, and thereby determines the current correction coefficient Kcr_W.

The selection circuit SELC50 outputs one of the current correction coefficients Kcr_U, Kcr_V, Kcr_W of the u-phase, the v-phase, and the w-phase, in accordance with the phase selection signal SEL. As described above, the drive voltage amplitudes of the respective phases are determined by the current correction coefficients Kcr_U, Kcr_V, Kcr_W of the respective phases, so that the drive current amplitudes of the respective phases are determined.

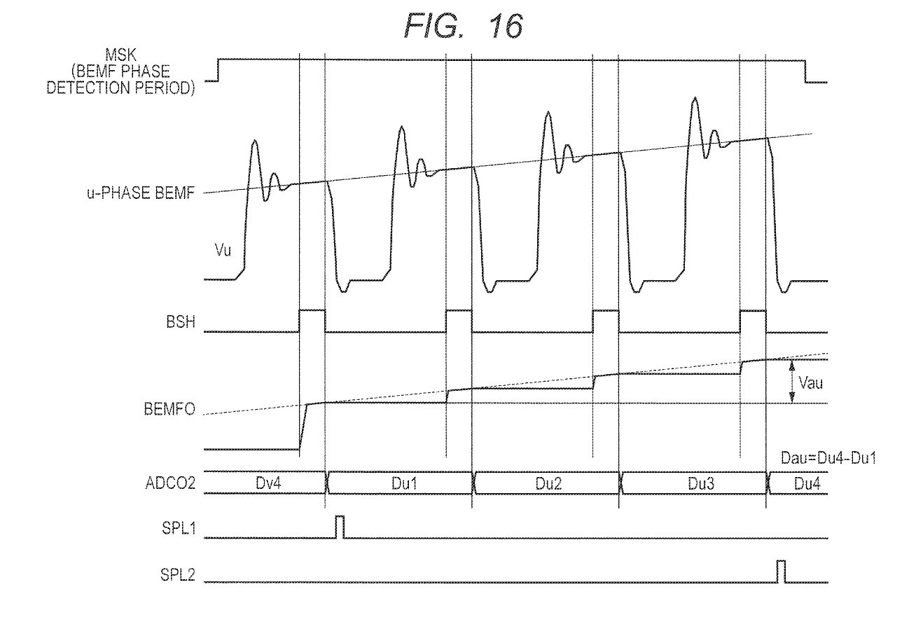

FIG. 16 is a waveform diagram for explaining an operation example of the interphase amplitude variation correction unit of FIG. 15. As described with FIG. 8 etc., the back electromotive force voltage phase detection unit (back electromotive force voltage amplitude detection unit) BPHD of FIG. 6 samples a voltage (one of Vu, Vv, Vw) at the drive terminal multiple times in a time series manner in accordance with the sampling signal BSH during the assertion period in the state where the drive terminal of the selected phase is set to high impedance during the assertion period of the mask signal MSK. The sampling signal BSH is asserted every PWM cycle. Then, the back electromotive force voltage phase detection unit (back electromotive force voltage amplitude detection unit) BPHD sequentially outputs sampling voltages (i.e., back electromotive force voltage amplitudes BEMFO) while performing multiple times of sampling, and the analog-digital converter ADC2 outputs the digital values ADCO2 of the back electromotive force voltage amplitudes BEMFO.

The interphase amplitude variation correction unit AMDCP of FIG. 15 functions as a part of the back electromotive force voltage amplitude detection unit. The interphase amplitude variation correction unit AMDCP calculates a difference value based on sampling voltages for predetermined two times among the sampling voltages (i.e., the digital values ADCO2) for the multiple times (four times in the example of FIG. 16) as described above, and detects the difference value as the back electromotive force voltage amplitude. In the example of FIG. 16, for example, in a state where the selected phase is the u phase, the sampling signal SPL1 is asserted in the output period of a digital value Du1 of the first sampling voltage by the analog-digital converter ADC2, and the sampling signal SPL2 is asserted in the output period of a digital value Du4 of the fourth sampling voltage.

The interphase amplitude variation correction unit AMDCP latches the digital value Du1 in the register circuit REG50u1, latches the digital value Du4 in the register circuit REG50u2, and detects the difference value (Du4−Du1) as the back electromotive force voltage amplitude Dau. That is, the interphase amplitude variation correction unit AMDCP detects the change amount of the BEMF in the assertion period of the mask signal MSK as the back electromotive force voltage amplitude.

By using this method, it is possible to accurately detect the back electromotive force voltage amplitude. That is, as described with FIG. 8 etc., the assertion period of the mask signal MSK is always maintained by the PLL control unit PLLCT at the fixed period (e.g., 15 degrees) with the voltage zero-cross point of the BEMF as the intermediate time. Therefore, the detection period of the BEMF amplitude also does not vary on the time axis, and is always maintained in the same electrical-angle range in 360 degrees. Thus, since the detection period does not vary, the detection accuracy of the back electromotive force voltage amplitude is enhanced.

Further, the PWM cycle is a cycle calculated by dividing by an integer (e.g., 96) the rotation cycle count value NCNT obtained by the PLL control unit PLLCT, and by synchronization with the rotation cycle, it is possible to synchronize the detection timing of the BEMF amplitude to PLL control and enhance the detection accuracy of the back electromotive force voltage amplitude.

Further, since some of the circuits for detecting the back electromotive force voltage phase are also used to detect the back electromotive force voltage amplitude, there are cases where the overhead of a circuit area can be suppressed. While the analog-digital converter ADC2 for detecting the back electromotive force voltage amplitude is provided separately in this specification, it is possible to use the analog-digital converter ADC as the analog-digital converter ADC2 as well. That is, the analog-digital converter ADC does not need to detect the phase current at all times, and can also detect the back electromotive force voltage amplitude for an idle period.

Thus, by using the motor drive device and the motor system according to the second embodiment, various effects described in the first embodiment are obtained, and by providing the interphase amplitude variation correction unit AMDCP, it is possible to further reduce the torque ripple of the motor SPM. While it is preferable to correct both the interphase phase variation and amplitude variation as shown in FIG. 13; for example, by correcting only the amplitude variation, it is possible to reduce the torque ripple of the motor SPM to some extent.

Further, in practical use, the interphase amplitude variation correction can be executed, for example, when the motor system is started or when external environment is changed, like the phase variation correction. In this case, to be precise, when one of the amplitude and the phase is changed, the other is also changed (i.e., there is dependency relationship therebetween); therefore, for example, it is preferable to perform sequential processing in which one is adjusted after the other is adjusted, instead of adjusting both of them concurrently in an overlap period at the startup.

While the invention made above by the present inventors has been described specifically based on the illustrated embodiments, the present invention is not limited thereto, and various changes and modifications can be made thereto without departing from the spirit and scope of the invention. For example, the above embodiments are detailed to make the present invention easily understood, and the present invention is not necessarily limited to an embodiment having all of the above-described configurations. A part of the configuration of an embodiment can be replaced by the configuration of another embodiment, and the configuration of an embodiment can be added to the configuration of another embodiment. With respect to a part of the configuration of each of the embodiments, addition of another configuration, deletion, and replacement can be performed.

For example, the method of each embodiment is applicable as the driving method of various motors in the HDD device, a DVD playback/recording device, Blu-ray playback/recording device, and the like.

What is claimed is:

1. A motor drive device for driving a motor of multiple phases, the motor drive device comprising:
an inverter unit which includes a plurality of high side transistors and low side transistors coupled to drive terminals of the multiple phases respectively, and applies drive voltages to the drive terminals, using a PWM (Pulse Width Modulation) signal;
a back electromotive force voltage phase detection unit which detects each of back electromotive force voltage phases of the multiple phases; and
a drive voltage phase generation unit which determines one of drive voltage phases in each of the multiple phases at the time of applying the drive voltages to the drive terminals so that each of drive current phases of the multiple phases has a phase variation opposite in direction and equal to each of relative phase variations of the back electromotive force voltage phases of the multiple phases.

2. The motor drive device according to claim 1, further comprising a phase error detection unit which determines, as a reference voltage phase, an average or representative phase of the back electromotive force voltage phases of the multiple phases detected by the back electromotive force voltage phase detection unit, and detects each of voltage phase error between each of the back electromotive force voltage phases of the multiple phases and the reference voltage phase, to each of the multiple phases.

3. The motor drive device according to claim 2, further comprising a drive current phase detection unit which detects a drive current phase of at least one of the multiple phases, and determines, as a reference current phase, an average or representative phase of the detected drive current phase,
wherein the drive voltage phase generation unit comprises:
a reference drive voltage phase generation unit which determines a reference drive voltage phase at the time of applying the drive voltage so that a phase difference between the reference voltage phase and the reference current phase is set to zero; and
an interphase phase variation correction unit which corrects the reference drive voltage phase by reflecting one of the voltage phase errors in each of the multiple phases detected by the phase error detection unit, and thereby determines one of the drive voltage phases in each of the multiple phases at the time of applying the drive voltage.

4. The motor drive device according to claim 3,
wherein the interphase phase variation correction unit comprises:
a multiplier which multiplies one of the voltage phase errors in each of the multiple phases detected by the phase error detection unit by a gain parameter; and
a plurality of adders which add multiplication results to each of the multiple phases calculated by the multiplier to the reference drive voltage phase,
wherein the gain parameter is a coefficient indicating sensitivity of the drive voltage phase to a shift amount of the back electromotive force voltage phase, in a relational expression between the back electromotive force voltage phase and the drive voltage phase obtained in a state where the back electromotive force voltage phase is shifted and the drive current phase is shifted by the same amount as and in an opposite direction of the back electromotive force voltage phase with respect to a state where the back electromotive force voltage phase and the drive current phase match with each other.

5. The motor drive device according to claim 3,
wherein the reference drive voltage phase generation unit comprises:
a phase calculation unit which calculates the drive voltage phase for setting the phase difference between the reference voltage phase and the reference current phase to zero, based on a calculation expression using a current value of a drive current of the motor, an angular frequency of the motor, and a predetermined characteristic constant of the motor; and
a phase correction unit which adds a correction value to the drive voltage phase calculated by the phase calculation unit, thereby generates the reference drive voltage phase, and updates magnitude of the correction value by feedback control so that the phase difference between the reference voltage phase and the reference current phase converges to zero.

6. The motor drive device according to claim 2, further comprising:
a back electromotive force voltage amplitude detection unit which detects each of back electromotive force voltage amplitudes of the multiple phases;
a drive current amplitude detection unit which detects each of drive current amplitudes of the multiple phases; and
an interphase amplitude variation correction unit which determines one of drive voltage amplitudes in each of the multiple phases at the time of applying the drive voltages to the drive terminals so that each of the drive current amplitudes of the multiple phases has an amplitude variation that is a reciprocal of a relative amplitude variation to each of the back electromotive force voltage amplitudes of the multiple phases.

7. The motor drive device according to claim 6, further comprising a PLL control unit which generates a timing signal which periodically transitions, and controls the timing signal by a PLL (Phase Locked Loop) so that a phase difference between a phase of the timing signal and the reference voltage phase converges to zero,
wherein the back electromotive force voltage phase detection unit detects a timing when a sampling voltage passes through a voltage zero-cross point, and thereby detects the back electromotive force voltage phase, while sampling a voltage at the drive terminal multiple times in a time series manner during a first period in a state where the drive terminal of a phase subjected to detection among the multiple phases is set to high impedance during the first period,
wherein the back electromotive force voltage amplitude detection unit calculates a difference value based on sampling voltages for predetermined two times among sampling voltages for the multiple times acquired by the back electromotive force voltage phase detection unit, and detects the calculated difference value as the back electromotive force voltage amplitude, and
wherein the first period is in a predetermined electrical-angle range on the basis of the timing signal by the PLL control unit.

8. The motor drive device according to claim 6,
wherein the interphase amplitude variation correction unit comprises:
an average value calculation unit which calculates an average value of the back electromotive force voltage amplitudes of the multiple phases detected by the back electromotive force voltage amplitude detection unit; and
an amplitude ratio calculation unit which calculates “x/y” to each of the multiple phases and thereby determines one of the drive voltage amplitudes in each of the multiple phases, where ‘y’ denotes the back electromotive force voltage amplitude to each of the multiple phases and ‘x’ denotes the average value of the back electromotive force voltage amplitudes.

9. A motor drive device for driving a motor of multiple phases provided outside, the motor drive device comprising:
an inverter unit which includes a plurality of high side transistors and low side transistors coupled to drive terminals of the multiple phases respectively, and applies drive voltages to the drive terminals, using a PWM (Pulse Width Modulation) signal;
a back electromotive force voltage amplitude detection unit which detects each of back electromotive force voltage amplitudes of the multiple phases;
a drive current amplitude detection unit which detects each of drive current amplitudes of the multiple phases; and
an interphase amplitude variation correction unit which determines one of drive voltage amplitudes in each of the multiple phases at the time of applying the drive voltages to the drive terminals so that each of the drive current amplitudes of the multiple phases has an amplitude variation that is a reciprocal of a relative amplitude variation to each of the back electromotive force voltage amplitudes of the multiple phases.

10. The motor drive device according to claim 9, further comprising:
a back electromotive force voltage phase detection unit which detects each of back electromotive force voltage phases of the multiple phases;
a phase error detection unit which determines, as a reference voltage phase, an average or representative phase of the back electromotive force voltage phases of the multiple phases detected by the back electromotive force voltage phase detection unit; and
a PLL control unit which generates a timing signal which periodically transitions, and controls the timing signal by a PLL (Phase Locked Loop) so that a phase difference between a phase of the timing signal and the reference voltage phase converges to zero,
wherein the back electromotive force voltage phase detection unit detects a timing when a sampling voltage passes through a voltage zero-cross point, and thereby detects the back electromotive force voltage phase, while sampling a voltage at the drive terminal multiple times in a time series manner during a first period in a state where the drive terminal of a phase subjected to detection among the multiple phases is set to high impedance during the first period,
wherein the back electromotive force voltage amplitude detection unit calculates a difference value based on sampling voltages for predetermined two times among sampling voltages for the multiple times acquired by the back electromotive force voltage phase detection unit, and detects the calculated difference value as the back electromotive force voltage amplitude, and
wherein the first period is in a predetermined electrical-angle range on the basis of the timing signal by the PLL control unit.

11. The motor drive device according to claim 9,
wherein the interphase amplitude variation correction unit comprises:
an average value calculation unit which calculates an average value of the back electromotive force voltage amplitudes of the multiple phases detected by the back electromotive force voltage amplitude detection unit; and
an amplitude ratio calculation unit which calculates “x/y” to each of the multiple phases and determines one of the drive voltage amplitudes in each of the multiple phases based on a calculation result, where ‘y’ denotes the back electromotive force voltage amplitude to each of the multiple phases and ‘x’ denotes the average value of the back electromotive force voltage amplitudes.

12. A motor system comprising:
a disk for storing data;
a motor for rotating the disk; and
a motor drive device for driving the motor by sine waves of three phases,
wherein the motor drive device comprises:
an inverter unit which includes three sets of high side transistors and low side transistors coupled to drive terminals of the three phases respectively, and applies drive voltages to the drive terminals, using a PWM (Pulse Width Modulation) signal;
a back electromotive force voltage phase detection unit which detects each of back electromotive force voltage phases of the three phases; and
a drive voltage phase generation unit which determines one of drive voltage phases in each of the three phases at the time of applying the drive voltages to the drive terminals so that drive current phases of the three phases has a phase variation opposite in direction and equal to each of relative phase variations of the back electromotive force voltage phases of the three phases.

13. The motor system according to claim 12, wherein the motor drive device further comprises a phase error detection unit which determines, as a reference voltage phase, an average or representative phase of the back electromotive force voltage phases of the three phases detected by the back electromotive force voltage phase detection unit, and detects a voltage phase error between each of the back electromotive force voltage phases of the three phases and the reference voltage phase, to each of the three phases.

14. The motor system according to claim 13,
wherein the motor drive device further comprises a drive current phase detection unit which detects a drive current phase of at least one of the three phases, and determines, as a reference current phase, an average or representative phase of the detected drive current phase,
wherein the drive voltage phase generation unit comprises:
a reference drive voltage phase generation unit which determines a reference drive voltage phase at the time of applying the drive voltage so that a phase difference between the reference voltage phase and the reference current phase is set to zero; and
an interphase phase variation correction unit which corrects the reference drive voltage phase by reflecting one of the voltage phase errors in each of the three phases detected by the phase error detection unit, and thereby determines one of the drive voltage phases in each of the three phases at the time of applying the drive voltage.

15. The motor system according to claim 14,
wherein the interphase phase variation correction unit comprises:
a multiplier which multiplies one of the voltage phase errors in each of the three phases detected by the phase error detection unit by a gain parameter; and
a plurality of adders which add one of multiplication results in each of the three phases calculated by the multiplier to the reference drive voltage phase,
wherein the gain parameter is a coefficient indicating sensitivity of the drive voltage phase to a shift amount of the back electromotive force voltage phase in a relational expression between the back electromotive force voltage phase and the drive voltage phase obtained in a state where the back electromotive force voltage phase is shifted and the drive current phase is shifted by the same amount as and in an opposite direction of the back electromotive force voltage phase with respect to a state where the back electromotive force voltage phase and the drive current phase match with each other.

16. The motor system according to claim 14,
wherein the reference drive voltage phase generation unit comprises:
a phase calculation unit which calculates the drive voltage phase for setting the phase difference between the reference voltage phase and the reference current phase to zero, based on a calculation expression using a current value of a drive current of the motor, an angular frequency of the motor, and a predetermined characteristic constant of the motor; and
a phase correction unit which adds a correction value to the drive voltage phase calculated by the phase calculation unit, thereby generates the reference drive voltage phase, and updates magnitude of the correction value by feedback control so that the phase difference between the reference voltage phase and the reference current phase converges to zero.

17. The motor system according to claim 13, further comprising:
a back electromotive force voltage amplitude detection unit which detects each of back electromotive force voltage amplitudes of the three phases;
a drive current amplitude detection unit which detects each of drive current amplitudes of the three phases; and
an interphase amplitude variation correction unit which determines one of drive voltage amplitudes in each of the three phases at the time of applying the drive voltages to the drive terminals so that each of the drive current amplitudes of the three phases have amplitude variation that is a reciprocal of a relative amplitude variation to each of the back electromotive force voltage amplitudes of the three phases.

18. The motor system according to claim 17,
wherein the motor drive device further comprises:
a PLL control unit which generates a timing signal which periodically transitions, and controls the timing signal by a PLL (Phase Locked Loop) so that a phase difference between a phase of the timing signal and the reference voltage phase converges to zero,
wherein the back electromotive force voltage phase detection unit detects a timing when a sampling voltage passes through a voltage zero-cross point, and thereby detects the back electromotive force voltage phase, while sampling a voltage at the drive terminal multiple times in a time series manner during a first period in a state where the drive terminal of a phase subjected to detection among the three phases is set to high impedance during the first period,
wherein the back electromotive force voltage amplitude detection unit calculates a difference value based on sampling voltages for predetermined two times among sampling voltages for the multiple times acquired by the back electromotive force voltage phase detection unit, and detects the calculated difference value as the back electromotive force voltage amplitude, and
wherein the first period is in a predetermined electrical-angle range on the basis of the timing signal by the PLL control unit.

19. The motor system according to claim 17,
wherein the interphase amplitude variation correction unit comprises:
an average value calculation unit which calculates an average value of the back electromotive force voltage amplitudes of the three phases detected by the back electromotive force voltage amplitude detection unit; and
an amplitude ratio calculation unit which calculates “x/y” to each of the three phases and thereby determines one of the drive voltage amplitudes in each of the three phases, where ‘y’ denotes the back electromotive force voltage amplitude to each of the three phases and ‘x’ denotes the average value of the back electromotive force voltage amplitudes.

20. The motor system according to claim 12, wherein the disk is a hard disk.
